(19) United States
(12) Patent Application Publication
(10) Pub. No.: US 2011/0101913 A1
(43) Pub. Date: May 5, 2011

(54) ELECTRONIC DEVICE AND POWER SOURCE CONTROL DEVICE

(75) Inventors: Shuji MATSUMOTO, Kawasaki (JP); Youichi Kondou, Kawasaki (JP)

(73) Assignee: FUJITSU LIMITED, Kawasaki-shi (JP)

(21) Appl. No.: 12/917,542

(22) Filed: Nov. 2, 2010

(30) Foreign Application Priority Data
Nov. 4, 2009 (JP) 2009-253049

(51) Int. Cl. H02J 7/00; H02J 7/04

(52) U.S. Cl. 320/107; 320/162

(57) ABSTRACT

An electronic device including a first body having a first battery; and a second body having a second battery, the second body being configured to be electrically connected to the first body and separatable from the first body; the first body including: receiving a request for charge of battery from the first body or the second body; retrieving a remaining amount of battery inside the first body and the second body; comparing the battery of the first body and the battery of the second battery on the basis of the retrieved remaining amount of battery; carrying out a charging process for the requested battery indicated by the received request in case that a power source including the not-requested battery satisfies a predetermined requirement as a result of the comparing.

### CROSS-REFERENCE TO RELATED APPLICATIONS

This application is based upon and claims the benefit of priority of the prior Japanese Patent Application No. 2009-253049, filed on Nov. 4, 2009, the entire contents of which are incorporated herein by reference.

### BACKGROUND

1. Field

Embodiments discussed herein relate to an electronic device and a power source control device.

2. Description of the Related Art

Currently, electronic devices such as mobile terminal devices or the like have an increasing range of functions. Some mobile terminal devices can be used to perform, for example, various kinds of information processing operations such as verbal communication, document creation, accessing of websites, sending and receiving of e-mail messages, video reproduction, or the like. In addition, there are electronic devices that take various kinds of modified forms in which the electronic devices can be separated into two parts and used so that users can comfortably use such functions.

In order for the users to comfortably use the electronic devices, some of the electronic devices, which can be separated and used individually and independently include batteries and operate by consuming the charge of batteries thereof.

Regarding this, there is known a technique in which two devices, namely, a mobile terminal and a module that can be separated from the mobile terminal, are included, and a power source in the module is charged using a battery in the mobile terminal when the power source in the module is drained (for example, refer to Japanese Unexamined Patent Application Publication No. 2001-231065).

### SUMMARY

Embodiments discussed herein are related to an electronic device including a first body having a first battery; and a second body having a second battery, the second body being configured to be electrically connected to the first body and separatable from the first body.

The first body includes: a receiving unit that receives a charge request from the first body or the second body, the charge request being associated with the first battery or the second battery; a retrieval unit that retrieves a remaining amount of battery charge of the first battery and a remaining amount of charge of the second battery; a comparison unit that compares the remaining amount of battery charge of the first battery and the remaining amount of battery charge of the second battery; a control unit that carries out a charging process for the first battery or second battery associated with the charge request in a case that a power source including the first or second battery not associated with the charge request satisfies a condition based on the comparing.

The object and advantages of the invention will be realized and attained by the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWING

FIG. 1 illustrates an electronic device according to a first embodiment;

FIGS. 2A to 2F illustrate external appearance of a mobile terminal device according to a second embodiment;

FIGS. 3A and 3B illustrate external appearance of the mobile terminal device, which is in a mechanically separated state, according to the second embodiment;

FIGS. 4A to 4F illustrate external appearance of an input operation section according to the second embodiment;

FIGS. 5A to 5F illustrate external appearance of an information display section according to the second embodiment;

FIGS. 6A to 6F illustrate external appearance of the input operation section, which is in a stretched state, according to the second embodiment;

FIGS. 7A to 7F illustrate external appearance of the mobile terminal device, which is in a stretched state, according to the second embodiment;

FIG. 8 illustrates a hardware configuration of the mobile terminal device according to the second embodiment;

FIG. 9 illustrates a function of the mobile terminal device according to the second embodiment;

FIG. 10 illustrates a logic circuit for a switching control section according to the second embodiment;

FIG. 11 illustrates a processing operation performed when the input operation section and the information display section are charged using an adapter connected to the input operation section according to the second embodiment;

FIG. 12 illustrates a flow of the processing operation performed when the input operation section and the information display section are charged using the adapter connected to the input operation section according to the second embodiment;

FIG. 13 illustrates a battery power supply processing operation according to the second embodiment;

FIG. 14 illustrates a flow of the battery power supply processing operation according to the second embodiment;

FIG. 15 illustrates a processing operation for preferential battery charge according to the second embodiment; and

FIG. 16 illustrates a flow of the processing operation for preferential battery charge according to the second embodiment.

### DETAILED DESCRIPTION OF THE EMBODIMENTS

Regarding the above-mentioned electronic devices that can be separated and used, a user can individually use the devices in the mechanically separated state. Therefore, there is a probability that an imbalance between the devices occurs with respect to electric power consumption.

However, in a technique of related art, electric power transferred between batteries is transferred only in one direction. Therefore, for example, when the user mainly uses a device on a side that can supply electrically charging power using battery power, or the like, there occurs a case in which a battery that can supply electrically charging power has been drained first or prematurely. In such a case, although a battery on a side that can receive a supply of charging power has some energy left, the use of the side that can supply electrically charging power is disturbed.

A device disclosed hereinafter is capable of adjusting individual remaining battery levels of separable electronic devices between both devices.

For example, there is provided an electronic device that includes a first chassis capable of receiving electric power supplied from a second chassis. The first chassis includes a first contact section, a first switch, and a first switch control section used for controlling the first switch. The second chassis includes a second contact section configured to be electrically connected to the first contact section, a second battery section including a secondary battery configured to be electrically connected to the second contact section, and a second power source control section used for controlling battery charging for the second battery section. In addition, the second chassis is configured to take modified forms that include a first form, in which the second chassis is electrically connected to the first chassis with respect to a relationship between the first contact section and the second contact section, and a second form in which the second chassis is separated from the first chassis. The first switch is configured to set, in a switching manner, whether or not a first power source capable of supplying electric power for battery charging is electrically connected to the first contact section. When, using the first power source, the second power source control section charges the second battery section, the first switch control section causes the first switch to switch to a state in which the first contact section is electrically connected to the first power source.

In addition, for example, there is provided an electronic device configured to be connected to another electronic device and to receive electric power supplied from the other electronic device. The electronic device includes a contact section configured to be electrically connected to a contact section in the other electronic device, a switch, and a switch control section used for controlling the switch. In addition, the electronic device is configured to take modified forms that include a first form, in which the electronic device is electrically connected to the other electronic device with respect to a relationship between the contact section and the contact section in the other electronic device, and a second form in which the electronic device is separated from the other electronic device. The switch is configured to set, in a switching manner, whether or not a power source for supplying electric power for battery charging is electrically connected to the contact section. When the other electronic device is charged using the power source, the switch control section causes the switch to switch to a state in which the contact section is electrically connected to the power source.

In addition, for example, there is provided a power source control device that controls a power source in an electronic device configured to be connected to another electronic device and to receive electric power supplied from the other electronic device. The power source control device controls a switch configured to set, in a switching manner, whether or not a power source, which is capable of supplying electric power for battery charging, is electrically connected to a contact section, which is capable of being electrically connected to a contact section in the other electronic device, and causes the switch to switch to a state, in which the contact section is electrically connected to the power source, when the other electronic device is charged using the power source. According to the electronic device and the power source control device noted above, remaining battery levels of the separable electronic devices may be individually adjusted.

### First Embodiment

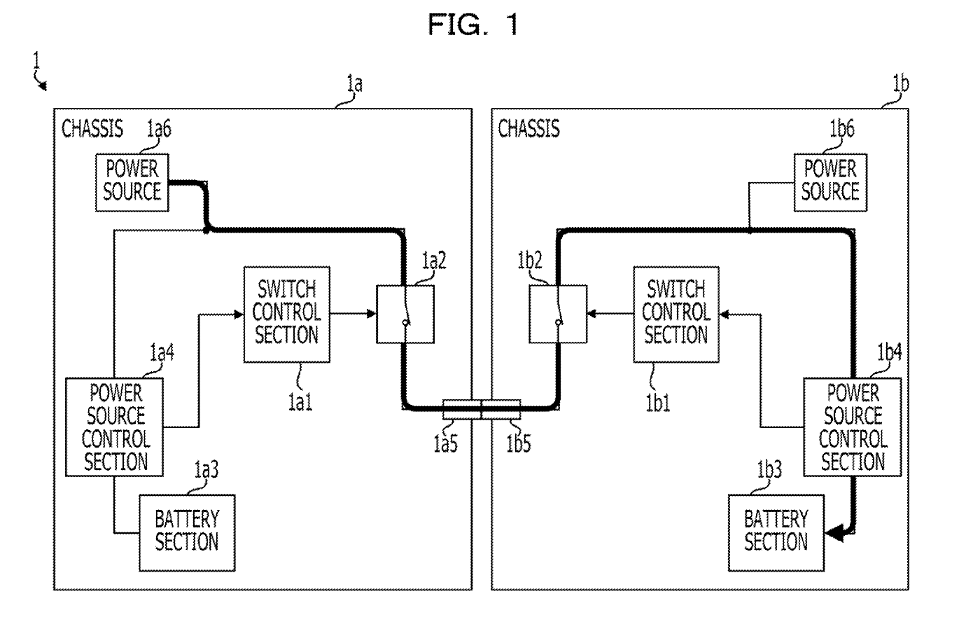

FIG. 1 illustrates an electronic device according to a first embodiment. Examples of an electronic device 1 according to a first embodiment includes a mobile terminal device, a mobile phone, a portable TV terminal, a portable video game player, and an electronic dictionary device, information processing devices such as e.g., a notebook computer and a personal digital assistant (PDA) or the like.

The electronic device 1 includes a chassis 1a (first chassis) and a chassis 1b (second chassis). The chassis 1b is separable from the chassis 1a. The electronic device 1 can be used in any one of a first state in which the chassis 1a is integrated with the chassis 1b and a second state in which the chassis 1a is separated from the chassis 1b. In addition, the chassis 1a and 1b can use power sources such as battery sections 1a3 and 1b3 and power sources 1a6 and 1b6 or the like, respectively, so the chassis 1a and 1b are operable independent from each other in a mechanically separated state (second state). In addition, a heavy line illustrated in FIG. 1 indicates a path through which electric power used for charging the battery section 1b3 is supplied from the power source 1a6.

The chassis 1a includes a switch control section 1a1 (first switch control section), a switch 1a2 (first switch), a battery section 1a3 (first battery section), a power source control section 1a4 (first power source control section), and a contact section 1a5 (first contact section). The chassis 1a may be configured to use the power source 1a6 (first power source). In addition, the chassis 1a may be configured to receive and use electric power supplied from the chassis 1b.

When a power source control section 1b4 charges the battery section 1b3 using the power source 1a6, the switch control section 1a1 causes the switch 1a2 to switch to a state in which the contact section 1a5 is electrically connected to the power source 1a6.

The switch 1a2 is configured to set, in a switching manner, whether or not the power source 1a6 that can supply electric power for battery charging is electrically connected to the contact section 1a5. When the switch 1a2 connects the power source 1a6 to the contact section 1a5, the electric power of the power source 1a6 is supplied to the chassis 1b. In addition, when the electric power of the power source 1a6 is not supplied to the chassis 1b, the switch 1a2 does not connect the power source 1a6 to the contact section 1a5.

The battery section 1a3 may include a secondary battery that can be electrically connected to the contact section 1a5. When there is no external power source, the chassis 1a may be configured to operate independently using electric power stored in the battery section 1a3.

The power source control section 1a4 controls a battery charging operation for the battery section 1a3, which uses electric power supplied from the chassis 1b or the like. The contact section 1a5 is configured to be electrically connected to the contact section 1b5. The contact sections 1a5 and 1b5 may include individual contact terminals, for example. In this case, the contact sections 1a5 and 1b5 are arranged so that contact terminals on the chassis 1a and 1b have contact with each other when the chassis 1a and 1b are in an integrated state. Accordingly, electric power may be transferred bidirectionally between the chassis 1a and 1b.

The power source 1a6 is used for operating the chassis 1a and charging the battery section 1b3. The power source 1a6 may be included in the chassis 1a or be an external power source, such as a power source adapter or the like, connected to the chassis 1a. In addition, the power source 1a6 may be the battery section 1a3. In addition, the power source 1a6 may be available for charging the battery section 1a3.

The chassis 1b includes a switch control section 1b1 (second switch control section), a switch 1b2 (second switch), a battery section 1b3 (second battery section), a power source control section 1b4 (second power source control section), and a contact section 1b5 (second contact section). The chassis 1b may be configured to use the power source 1b6 (second power source). In addition, the chassis 1b may take modified forms that include a first form, in which the chassis 1b is electrically connected to the chassis 1a with respect to a relationship between the contact section 1a5 and the contact section 1b5, and a second form in which the chassis 1b is separated from the chassis 1a. In addition, the chassis 1b may receive electric power supplied from the chassis 1a.

When the power source control section 1a4 charges the battery section 1a3 using the power source 1b6, the switch control section lbl causes the switch 1b2 to switch to a state in which the contact section 1a5 is electrically connected to the power source 1b6.

The switch 1b2 is configured to set, in a switching manner, whether or not the power source 1b6 that can supply electric power for battery charging is electrically connected to the contact section 1b5. When the switch 1b2 connects the power source 1b6 to the contact section 1b5, the electric power of the power source 1b6 may be supplied to the chassis 1a. In addition, when the electric power of the power source 1b6 is not supplied to the chassis 1a, the switch 1b2 does not connect the power source 1b6 to the contact section 1b5.

The battery section 1b3 includes a secondary battery configured to be electrically connected to the contact section 1b5. When there is no external power source, the chassis 1b may operate independently using electric power stored in the battery section 1b3.

The power source control section 1b4 controls a battery charging operation for the battery section 1b3, which uses electric power supplied from the chassis 1a or the like. The contact section 1b5 may be electrically connected to the contact section 1a5. The contact section 1b5 may include a contact terminal, as mentioned above.

The power source 1b6 is used for operating the chassis 1b and charging the battery section 1a3. The power source 1b6 may be included in the chassis 1b or be an external power source, such as a power source adapter or the like, connected to the chassis 1b. In addition, the power source 1b6 may be the battery section 1b3. In addition, the power source 1b6 may be available for charging the battery section 1b3.

For example, in the electronic device 1, when the battery section 1b3 is charged using electric power supplied from the power source 1a6, the supplied electric power is transferred to the battery section 1b3 through the switch 1a2, the contact sections 1a5 and 1b5, the switch 1b2, and the power source control section 1b4.

According to the electronic device 1, when there is an imbalance between individual remaining battery levels of separable electronic devices, both remaining battery levels may be adjusted. In addition, since a connection line is shared through which the devices supply electric power to each other, contacts and connection lines arranged between the chassis 1a and 1b in the electronic device 1 may be simplified.

In a second embodiment described hereinafter, as an application example of the electronic device 1 according to the first embodiment, a mobile terminal device will be cited. In this regard, however, as mentioned above, the electronic device 1 is applicable to various kinds of electronic devices other than the mobile terminal device.

### Second Embodiment

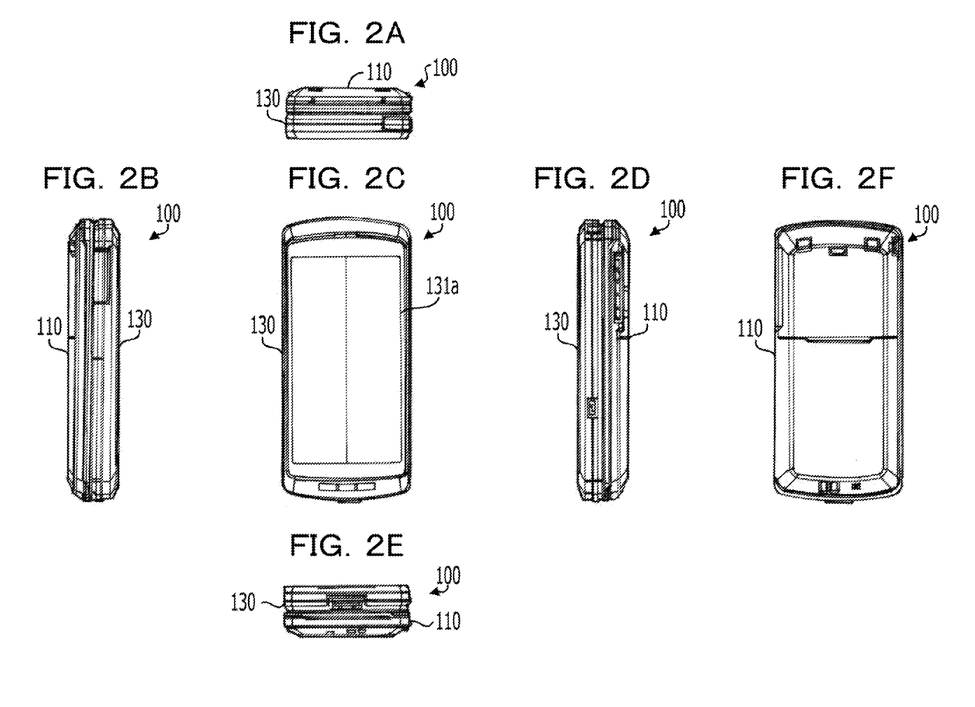

FIGS. 2A to 2F illustrate the external appearance of a mobile terminal device according to the second embodiment. FIG. 2A illustrates the top surface of the mobile terminal device according to the second embodiment. FIG. 2B illustrates the left side surface of the mobile terminal device according to the second embodiment. FIG. 2C illustrates the front surface of the mobile terminal device according to the second embodiment. FIG. 2D illustrates the right side surface of the mobile terminal device according to the second embodiment. FIG. 2E illustrates the bottom surface of the mobile terminal device according to the second embodiment. FIG. 2F illustrates the back surface of the mobile terminal device according to the second embodiment.

A mobile terminal device 100 according to the second embodiment is a mobile terminal device that includes a wireless verbal communication function. The mobile terminal device 100 includes an input operation section 110 and an information display section 130. The input operation section 110 is an example of the chassis 1a described above in the first embodiment, and the information display section 130 is an example of the chassis 1b in the first embodiment.

The mobile terminal device 100 illustrated in FIGS. 2A to 2F is integrated in a state in which the input operation section 110 overlaps with the information display section 130. In FIG. 2, the input operation section 110 is not extended as described later, but is in a housed state in which the input operation section 110 is retracted. The length along a longitudinal direction (height) and the length along a lateral direction (width) of the input operation section 110 are almost the same as the height and the width of the information display section 130, respectively. In the housed state, the side surface of the input operation section 110 nearly matches the side surface of the information display section 130. As illustrated in FIG. 2C, the information display section 130 includes a display 131a on the front thereof.

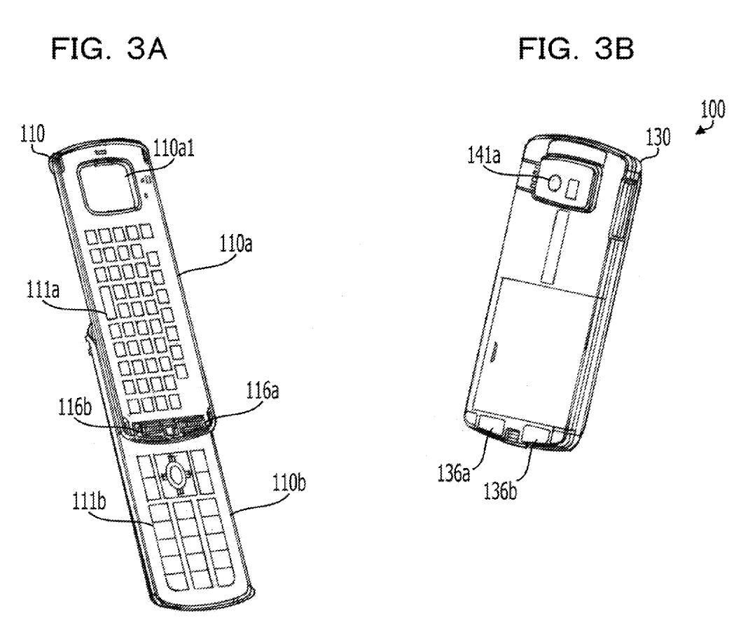

FIGS. 3A to 3B illustrate the external appearance of the mobile terminal device, which is in a mechanically separated state, according to the second embodiment. FIG. 3A illustrates the external appearance of an input operation section according to the second embodiment. FIG. 3B illustrates the external appearance of an information display section according to the second embodiment.

In the mobile terminal device 100 according to the embodiment, the input operation section 110 and the information display section 130 may also be used in a state in which the input operation section 110 is separated from the information display section 130. FIGS. 3A and 3B illustrate the input operation section 110 and the information display section 130 that are in a mechanically separated state.

As illustrated in FIG. 3A, the input operation section 110 includes a full keyboard section 110a and a numerical keypad section 110b. By sliding the full keyboard section 110 and the numerical keypad section 110b, the input operation section 110 can be alternately transformed into a housed state in which the numerical keypad section 110b is housed and a stretched state in which the numerical keypad section 110b is accessible.

The full keyboard section 110a includes a mating hole section 110a1 that mates to a camera section 141a in the information display section 130, a full keyboard 111a that receives the input of character information, and contact terminals 116a and 116b that may contact with and be electrically connected to contact terminals 136a and 136b included in the information display section 130, respectively. The numerical keypad section 110b includes a numerical keypad 111b that receives the input of numeric information may be used in connection with a telephone function operation, for example.

In the embodiment, in a first state in which the input operation section 110 and the information display section 130 in the mobile terminal device 100 are integrated with each other, the full keyboard 111a is housed in the mobile terminal device 100. In addition, when the mobile terminal device 100 is mechanically separated into the input operation section 110 and the information display section 130, the full keyboard 111a is exposed and may be used. In addition, when the mobile terminal device 100 is mechanically separated into the input operation section 110 and the information display section 130, and, furthermore, the input operation section 110 is put into the stretched state by sliding the input operation section 110, the numerical keypad 111b is exposed and may be used.

As illustrated in FIG. 3B, the information display section 130 includes the camera section 141a that captures a still image or a moving image, as well as the contact terminals 136a and 136b that may contact with and be electrically connected to the contact terminals 116a and 116b included in the input operation section 110, respectively. When, as described later, the input operation section 110 is integrated with the information display section 130, the camera section 141a mates to the mating hole section 110a1 included in the input operation section 110.

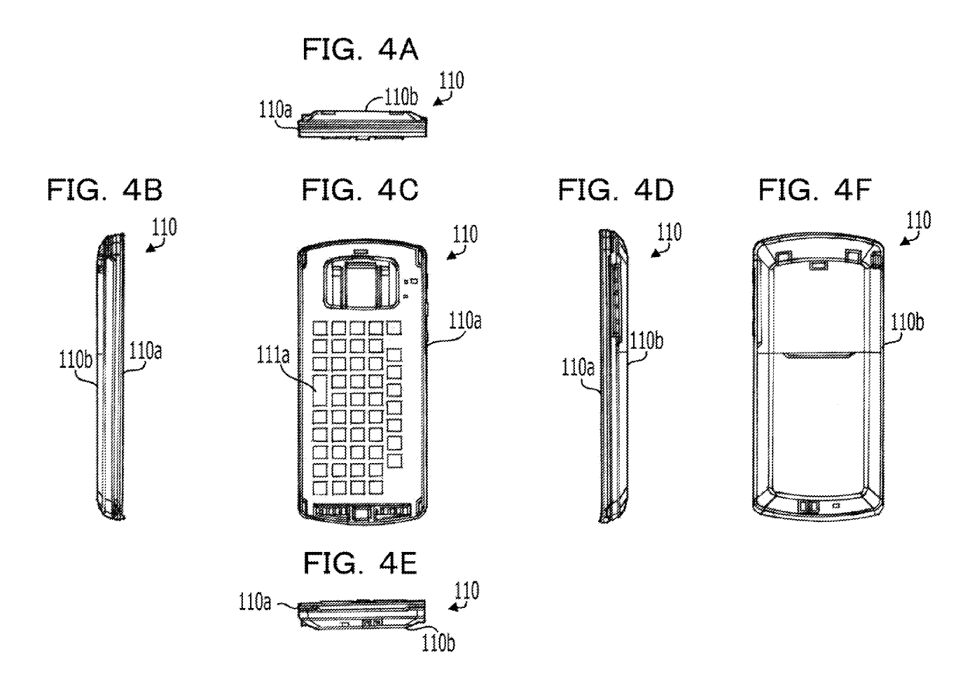

FIGS. 4A and 4F illustrate the external appearance of the input operation section according to the second embodiment. FIG. 4A illustrates the top surface of the input operation section according to the second embodiment. FIG. 4B illustrates the left side surface of the input operation section according to the second embodiment. FIG. 4C illustrates the front surface of the input operation section according to the second embodiment. FIG. 4D illustrates the right side surface of the input operation section according to the second embodiment. FIG. 4E illustrates the bottom surface of the input operation section according to the second embodiment. FIG. 4F illustrates the back surface of the input operation section according to the second embodiment.

The input operation section 110 illustrated in FIGS. 4A to 4F is separated from the information display section 130, and the full keyboard 111a in the full keyboard section 110a is exposed. In addition, the input operation section 110 is in a housed state in which the numerical keypad 111b in the numerical keypad section 110b is housed.

As illustrated in FIG. 4C, when the input operation section 110 is separated from the information display section 130 and is in the housed state, a user of the mobile terminal device 100 can input character information or the like using the full keyboard 111a. In addition, the input information may be transmitted to the information display section 130 using a wireless communication function described later.

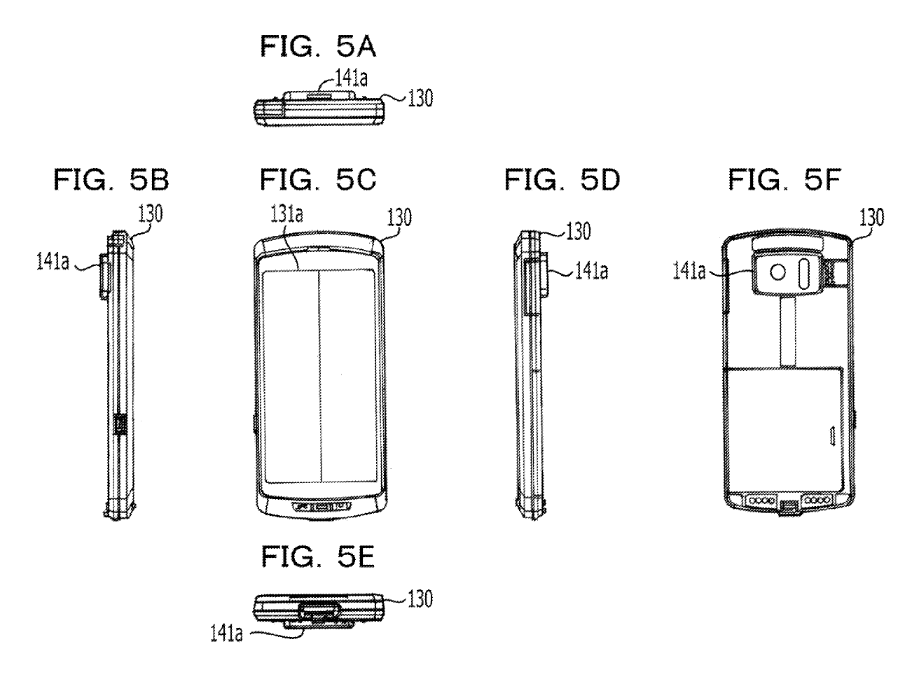

FIGS. 5A to 5F illustrate the external appearance of the information display section according to the second embodiment. FIG. 5A illustrates the top surface of the information display section according to the second embodiment. FIG. 5B illustrates the left side surface of the information display section according to the second embodiment. FIG. 5C illustrates the front surface of the information display section according to the second embodiment. FIG. 5D illustrates the right side surface of the information display section according to the second embodiment. FIG. 5E illustrates the bottom surface of the information display section according to the second embodiment. FIG. 5F illustrates the back surface of the information display section according to the second embodiment.

The information display section 130 illustrated in FIGS. 5A to 5F is in a state in which the information display section 130 is separated from the input operation section 110, the display 131a is arranged on the front face of the information display section 130, and the camera section 141a is arranged on the rear face of the information display section 130. When, as illustrated in FIG. 5C, the information display section 130 is separated from the input operation section 110, the user of the mobile terminal device 100 can cause the display 131a to display information that the mobile terminal device 100 obtains using the wireless communication function, information or the like that the input operation section 110 inputs, and information that the mobile terminal device 10 stores, for example. In addition, the user may capture a still image or a moving image using the camera section 141a.

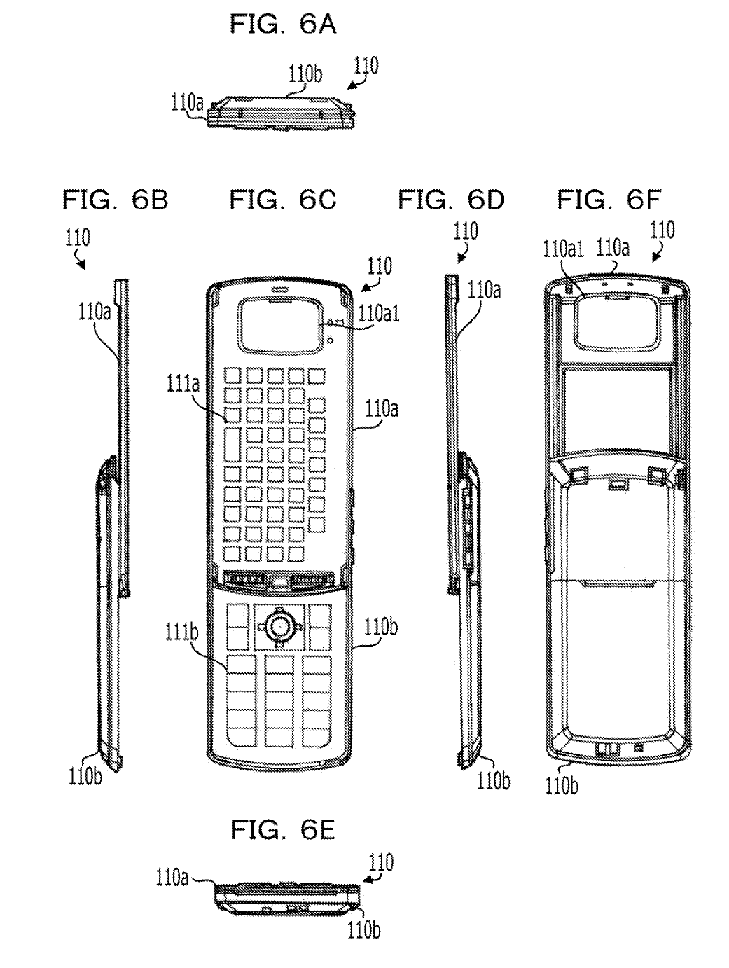

FIGS. 6A and 6F illustrate the external appearance of the input operation section, which is in a stretched state, according to the second embodiment. FIG. 6A illustrates the top surface of the input operation section, which is in the stretched state, according to the second embodiment. FIG. 6B illustrates the left side surface of the input operation section, which is in the stretched state, according to the second embodiment. FIG. 6C illustrates the front surface of the input operation section, which is in the stretched state, according to the second embodiment. FIG. 6D illustrates the right side surface of the input operation section, which is in the stretched state, according to the second embodiment. FIG. 6E illustrates the bottom surface of the input operation section, which is in the stretched state, according to the second embodiment. FIG. 6F illustrates the back surface of the input operation section, which is in the stretched state, according to the second embodiment.

The input operation section 110 illustrated in FIGS. 6A to 6F is separated from the information display section 130, and the full keyboard 111a in the full keyboard section 110a is exposed. In addition, the input operation section 110 is in a stretched state, in which the input operation section 110 is stretched by sliding the full keyboard section 110a and the numerical keypad section 110b. In the stretched state, the numerical keypad 111b in the numerical keypad section 110b is exposed. The input operation section 110 may include a rail section, not illustrated, so that the numerical keypad section 110b is slid and hence the input operation section 110 is alternately transformed into the stretched state and the housed state. In addition, the transformation of the state due to the sliding of the numerical keypad section 110b is not limited to the example but may be realized using another mechanism.

As illustrated in FIG. 6C, when the input operation section 110 is separated from the information display section 130 and is in the stretched state, the user of the mobile terminal device 100 can input character information or the like using the full keyboard 111a, as well as numeric information by operating the numerical keypad 111b. In addition, the input information may be transmitted to the information display section 130 using the wireless communication function described later.

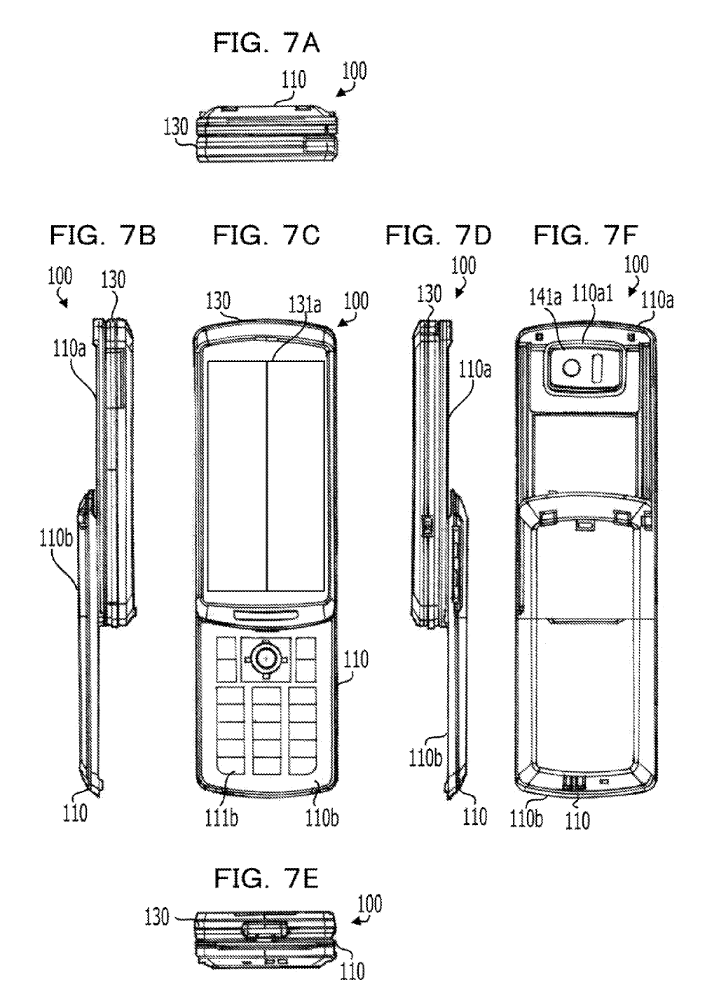

FIGS. 7A to 7F illustrate the external appearance of a mobile terminal device, which is in a stretched state, according to the second embodiment. FIG. 7A illustrates the top surface of the mobile terminal device, which is in the stretched state, according to the second embodiment. FIG. 7B illustrates the left side surface of the mobile terminal device, which is in the stretched state, according to the second embodiment. FIG. 7C illustrates the front surface of the mobile terminal device, which is in the stretched state, according to the second embodiment. FIG. 7D illustrates the right side surface of the mobile terminal device, which is in the stretched state, according to the second embodiment. FIG. 7E illustrates the bottom surface of the mobile terminal device, which is in the stretched state, according to the second embodiment. FIG. 7F illustrates the back surface of the mobile terminal device, which is in the stretched state, according to the second embodiment.

The mobile terminal device 100 illustrated in FIGS. 7A to 7F is in a stretched state, in which the input operation section 110 and the information display section 130 are integrated with each other, and the full keyboard section 110a and the numerical keypad section 110b in the input operation section 110 are slid and hence the numerical keypad 111b is exposed.

As illustrated in FIG. 7F, in the case in which the mobile terminal device 100 is in the stretched state, although the input operation section 110 and the information display section 130 are integrated with each other, the camera section 141a is exposed through the mating hole section 110a1 because the camera section 141a mates to the mating hole section 110a1 in the input operation section 110.

When, as illustrated in FIG. 7C, the mobile terminal device 100 is integrated and is in the stretched state, the user of the mobile terminal device 100 can input numeric information by operating the numerical keypad 111b and capture a still image or a moving image using the camera section 141a. The numeric information may be entered in connection with a telephone function operation, for example. In addition, the information input using the input operation section 110 is transmitted to the information display section 130 through the contact terminals 116a, 116b, 136a, and 136b.

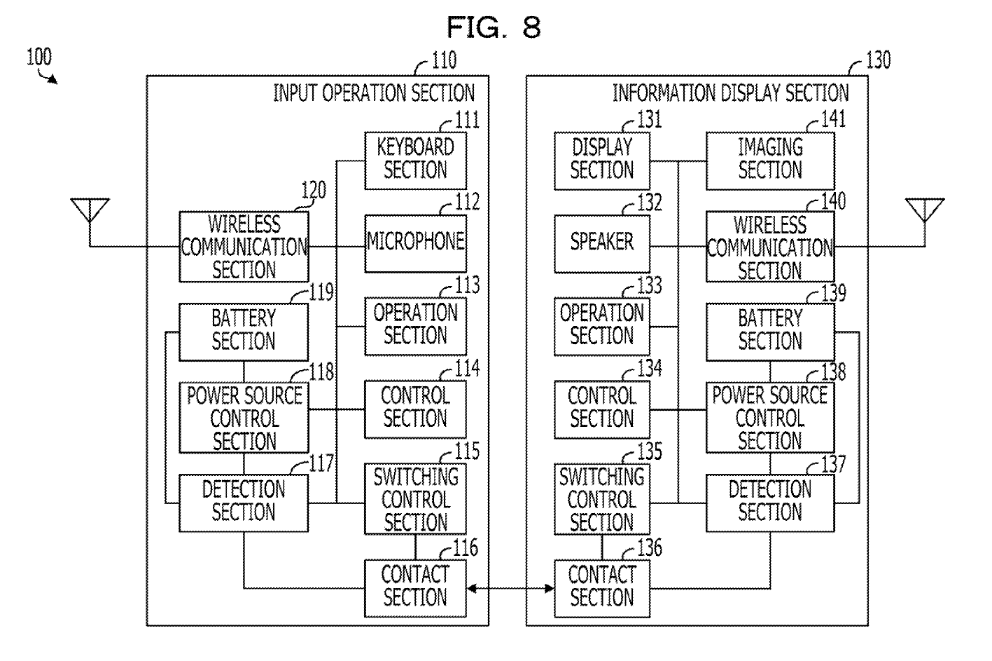

FIG. 8 illustrates the hardware configuration of the mobile terminal device according to the second embodiment. As described above, the mobile terminal device 100 according to the second embodiment includes the input operation section 110 and the information display section 130. The input operation section 110 and the information display section 130 may perform contact communication and wireless communication in order to perform various kinds of controls including controls for power sources included in individual devices. In addition, the input operation section 110 and the information display section 130 may be used independently from each other.

The input operation section 110 includes a keyboard section 111, a microphone 112, an operation section 113, a control section 114, a switching control section 115, a contact section 116, a detection section 117, a power source control section 118, a battery section 119, and a wireless communication section 120.

The keyboard section 111 includes the full keyboard 111a and the numerical keypad 111b, described above, and, by detecting a key operation thereof, receives the input of numeric information, character information, and other input information. When the keyboard section 111 detects the key operation, the keyboard section 111 outputs an input signal indicating an operated key to the control section 134 of the display section through the control section 114 of the input operation section.

The microphone 112 receives an audio input signal by converting a sonic physical oscillation into an electrical signal, and outputs the received audio input signal to the control section 134 of the display section through the control section 114 of the input operation section. For example, during the user's phone call, the user's voice and a background noise on the user's side are input to the microphone 112.

The operation section 113 includes an input device such as an operation key, an operation button, a touch panel, or the like, and receives operations such as a power on/off operation and switching between various kinds of modes or the like. The control section 114 controls the entire mobile terminal device 100. The control section 114 may be realized using, for example, a central processing unit (CPU), a random access memory (RAM), and a read only memory (ROM). In addition, for example, the control section 114 includes an interface such as an inter-integrated circuit (I2C), a serial peripheral interface (SPI), a universal asynchronous receiver transmitter (UART), a universal serial bus (USB), or the like, which can be connected to a peripheral device. The CPU reads out and deploys a program and data from the ROM and in the RAM, and executes the program. The RAM is a volatile memory used for temporarily storing a portion of the program or the data. In addition, in place of the RAM, other kinds of memories may be used. The ROM is a nonvolatile memory used for storing the program and the data that the control section 114 is to use. In addition, in place of the ROM, for example, a flash memory may be used. Control operations performed in the control section 114 include a communication control operation, an audio input/output control operation, and a key operation control operation or the like. In addition, the control section 114 controls, in a switching manner, a switch used to set whether or not individual sections in the input operation section 110, such as the contact section 116 and the battery section 119 or the like, are connected to the external power source or the like, such as the adapter or the like. Accordingly, when the battery section 119 is charged or supplies charging power, or the like, the connection state may be switched.

The switching control section 115 performs a switching control for a switch used to set whether or not individual sections in the input operation section 110 are connected to the external power source or the like, such as the adapter or the like. Accordingly, when the battery section 119 is charged or supplies charging power, or the like, the connection state may be switched.

The contact section 116 is electrically connected to the contact section 136 included in the information display section 130. In the input operation section 110, data communicated between the input operation section 110 and the information display section 130 and electric power that the input operation section 110 and the information display section 130 supply to each other are transmitted though the contact section 116. For example, the contact section 116 includes contact terminals such as the contact terminal 116a through which the input operation section 110 and the information display section 130 supply electric power to each other and the contact terminal 116b that performs an integration detection operation in which it is determined whether the input operation section 110 and the information display section 130 are in the integrated state or in the mechanically separated state.

The detection section 117 detects voltages of individual sections in the input operation section 110. Accordingly, it is detected whether or not the information display section 130 or the external power source supplies electric power to the input operation section 110, or the like. The power source control section 118 controls the supply of power to individual sections in the input operation section 110 from the battery section 119 or the external power source. In addition, the power source control section 118 detects the remaining battery level of the battery section 119. In addition, the power source control section 118 controls battery charging for the battery section 119. In addition, the power source control section 118 detects and gives notice of the charging status of the battery section 119.

The power source control section 118 has information (for example, graph, table, function, or the like) indicating a correspondence relationship between the remaining battery level of the battery section 119 and the interelectrode voltage of the battery section 119. The power source control section 118 detects the interelectrode voltage of the battery section 119, and detects the remaining battery level of the battery section 119 on the basis of the information indicating the correspondence relationship and the interelectrode voltage of the battery section 119.

The battery section 119 includes a secondary battery (storage battery) that stores electric charge. The battery section 119 may be charged by receiving electric power supplied from the external power source connected to the input operation section 110 or the information display section 130. The battery section 119 may be charged, repeatedly used as a battery, and supply electric power to the input operation section 110 using the secondary battery. While, as the battery, a lithium-ion battery is used in the embodiment, the embodiment is not limited to only the lithium-ion battery. Instead, all kinds of secondary batteries may be used as the battery according to example embodiments described herein.

The wireless communication section 120 performs wireless communication with the information display section 130 in accordance with the control of the control section 114. For example, the communications may be carried using communication methods such as e.g., Bluetooth (registered trademark), Zigbee, a wireless USB, and a wireless local area network (LAN) or the like.

The information display section 130 includes a display section 131, a speaker 132, an operation section 133, a control section 134, a switching control section 135, a contact section 136, a detection section 137, a power source control section 138, a battery section 139, a wireless communication section 140, and an imaging section 141.

The display section 131 performs various notification operations for the user by lighting various lamps or displaying various images on the display 131a in accordance with the control of the control section 134. In the display section 131, for example, light emitting diodes (LEDs) may be used as lamps. In addition, in the display section 131, a liquid crystal display (LCD) or an organic electro luminescence (EL) display may be used as the display 131a. Examples of images displayed on the display 131a include a standby screen, an operation screen, text, and a content picture or the like.

In accordance with the control of the control section 134, the speaker 132 converts an electrical signal into a physical oscillation and reproduces sound. For example, during the user's phone call, an intended party's voice and background noise on the intended party's side may be output from the speaker 132.

The operation section 133 includes an input device such as an operation key, an operation button, a touch panel, or the like, and receives operations such as a power on/off operation and a switching between modes operation, for example. The control section 134 controls the entire mobile terminal device 100. The control section 134 can be realized using, for example, a CPU, a RAM, and a ROM, in the same way as the control section 114. In addition, for example, the control section 134 includes an interface such as an I2C, a SPI, a UART, a USB, or the like, which can be connected to a peripheral device. The CPU reads out and deploys a program and data from the ROM and in the RAM, and executes the program. The RAM is a volatile memory used for temporarily storing a portion of the program or the data. In addition, in place of the RAM, other kinds of memories may be used. The ROM is a nonvolatile memory used for storing the program and the data that the control section 134 is to use. In addition, in place of the ROM, for example, a flash memory may be used. Control operations performed in the control section 134 include a communication control operation, an audio input/output control operation, and a key operation control operation or the like. In addition, the control section 134 controls, in a switching manner, a switch used to set whether or not individual sections in the information display section 130, such as the contact section 136 and the battery section 139 or the like, are connected to the external power source or the like, such as the adapter or the like. Accordingly, when the battery section 139 is charged or supplies charging power, or the like, the connection state may be switched.

The switching control section 135 performs a switching control for a switch used to set whether or not individual sections in the input operation section 130 are connected to the external power source or the like, such as the adapter or the like. Accordingly, when the battery section 139 is charged or supplies charging power, or the like, the connection state may be switched.

The contact section 136 is electrically connected to the contact section 116 included in the input operation section 110. In the information display section 130, data communicated between the input operation section 110 and the information display section 130 and electric power that the input operation section 110 and the information display section 130 supply to each other are transmitted through the contact section 136. For example, the contact section 136 includes contact terminals such as the contact terminal 136a through which the input operation section 110 and the information display section 130 supply electric power to each other and the contact terminal 136b that performs an integration detection operation in which it is determined whether the input operation section 110 and the information display section 130 are in the integrated state or in the mechanically separated state.

The detection section 137 detects voltages of individual sections in the information display section 130. Accordingly, it is detected whether or not the information display section 130 or the external power source supplies electric power to the information display section 130, or the like. The power source control section 138 controls the supply of power to individual sections in the information display section 130 from the battery section 139 or the external power source. In addition, the power source control section 138 detects the remaining battery level of the battery section 139. In addition, the power source control section 138 controls battery charging for the battery section 139. In addition, the power source control section 138 detects and gives notice of the charging status of the battery section 139.

The power source control section 138 has information indicating a correspondence relationship between the remaining battery level of the battery section 139 and the interelectrode voltage of the battery section 139. The power source control section 138 detects the interelectrode voltage of the battery section 139, and detects the remaining battery level of the battery section 139 on the basis of the information indicating the correspondence relationship and the interelectrode voltage of the battery section 139.

The battery section 139 includes a secondary battery (storage battery) that stores electric charge. The battery section 139 may be charged by receiving electric power supplied from the external power source connected to the information display section 130 or the input operation section 110. The battery section 139 may be charged, repeatedly used as a battery, and supply electric power to the information display section 130 using the secondary battery. While, as the battery, a lithium-ion battery is used in the embodiment, the embodiment is not limited to only the lithium-ion battery. Instead, all kinds of secondary batteries may be used as the battery according to an example embodiment.

The wireless communication section 140 performs wireless communication with the input operation section 110 in accordance with the control of the control section 134. In addition, the wireless communication section 140 performs wireless communication with a public line in accordance with the control of the control section 134. The wireless communication section 140 uses, for example, one of communication methods such as e.g., Bluetooth, Zigbee, a wireless USB, and a wireless LAN or the like. In addition, the wireless communication section 140 may directly wireless-communicate with the public line, using, for example, a mobile communication such as a wideband code division multiple access (W-CDMA) communication or the like, or communicate with the public line through a wireless LAN such as IEEE802.11a/b/g/n or the like.

The imaging section 141 includes a camera section 141a, and converts a still image or a moving image, captured by the camera section 141a, into image data. In addition, the input operation section 110 and the information display section 130 include the power source control sections 118 and 138 and the battery sections 119 and 139, respectively, so that the input operation section 110 and the information display section 130 may operate independently in the mechanically separated state.

A power-off state includes a standby state in which functions other than both a power source operation for one device and a function used for monitoring the power source of the other device are restricted, and hence power consumption is reduced. For example, the power-off state includes a state in which power is not supplied to individual sections other than power source control sections (for example, the power source control section 118 in the case of the input operation section 110) in individual devices.

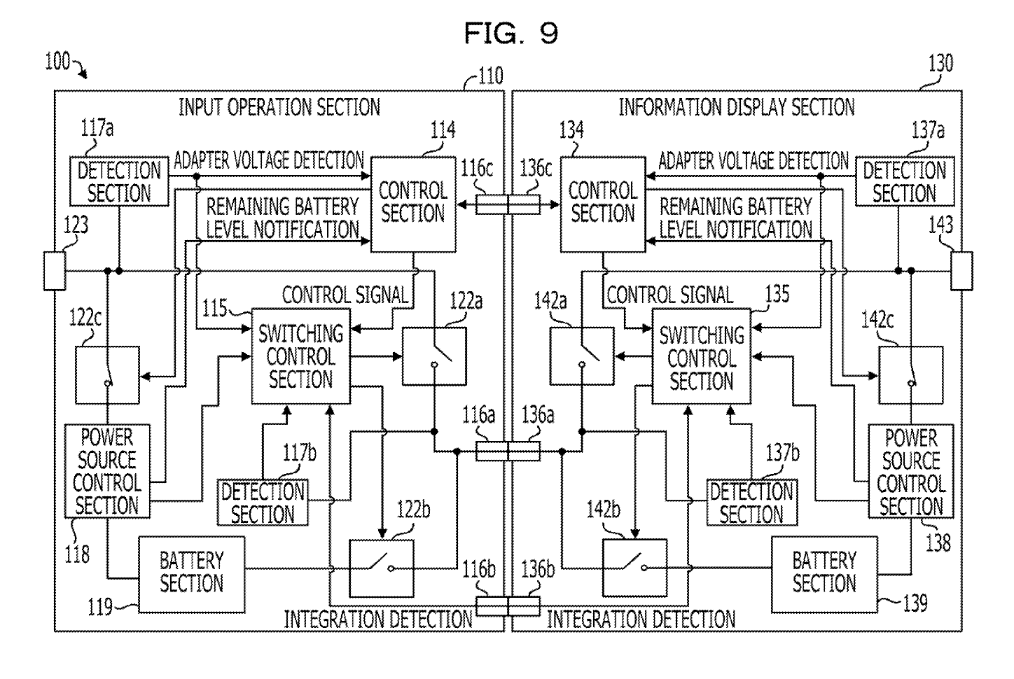

FIG. 9 illustrates the function of the mobile terminal device according to the second embodiment. Descriptions relating to functions other than a battery charge control function are omitted for the sake of brevity. The mobile terminal device 100 includes the input operation section 110 (first chassis) and the information display section 130 (second chassis). The information display section 130 may be separated from the input operation section 110. The mobile terminal device 100 may be used in a first state in which the input operation section 110 is integrated with the information display section 130 and a second state in which the input operation section 110 is separated from the information display section 130. In addition, the input operation section 110 may receive electric power supplied from the information display section 130. Further, the information display section 130 may receive electric power supplied from the input operation section 110. In addition, the input operation section 110 and the information display section 130 are configured to take modified forms that include a first form (integrated state), in which the input operation section 110 is mechanically and electrically connected to the information display section 130 with respect to a relationship between the contact section 116 and the contact section 136, and a second form (mechanically separated state) in which the input operation section 110 is separated from the information display section 130.

The control section 114 obtains signals transmitted from a detection section 117a, the power source control section 118, and the control section 134. In addition, by transmitting a control signal to the switching control section 115 on the basis of the obtained signals, the control section 114 causes the switching control section 115 to control switches 122a and 122b. In addition, the control section 114 controls a switch 122c on the basis of the obtained signals. The switching control section 115 controls the switches 122a and 122b on the basis of the control signal transmitted from the control section 114 and signals obtained from the detection section 117a, a detection section 117b, the power source control section 118, and the contact terminal 116b. The control section 114 and the switching control section 115 function as a switch control section.

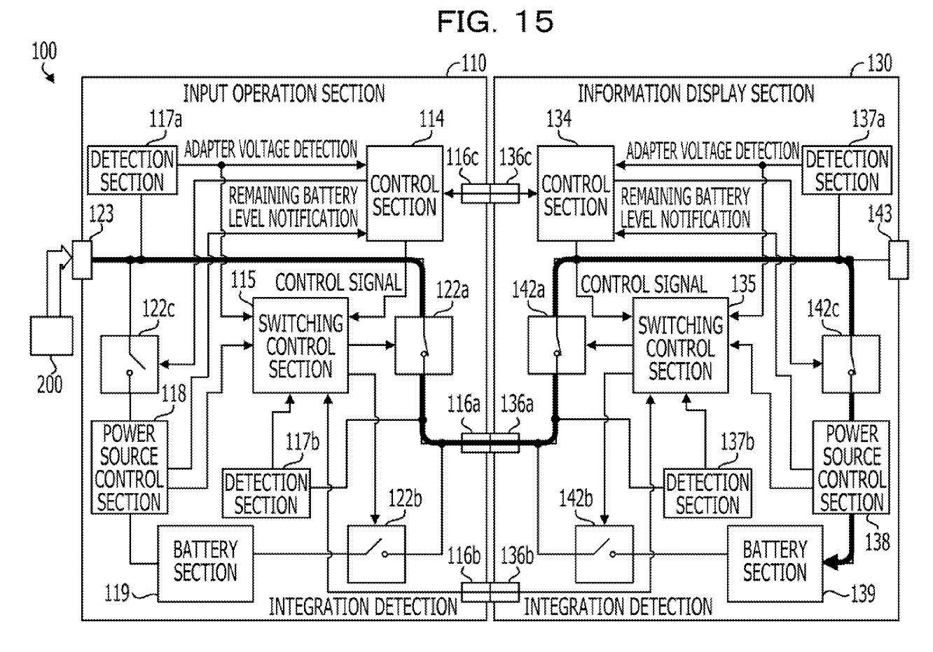

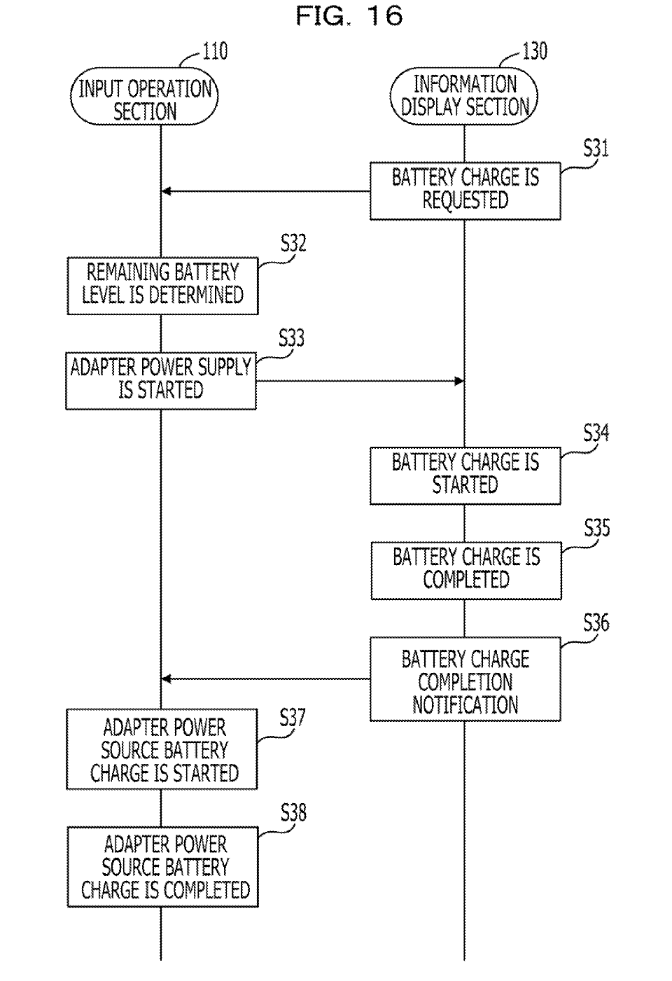

When a battery charging operation, described later with reference to FIGS. 15 and 16, is performed, the control section 114 may determine the completion of the battery charging operation by comparing the remaining battery level of the battery section 119 with a specified voltage, which is lower than a remaining battery level at the time of full charge, on the basis of the detection of the remaining battery level of the battery section 119, performed by the power source control section 118. Accordingly, when the battery charging operation is performed, the battery section 119 and the battery section 139 are charged effectively.

When the power source control section 138 charges the battery section 139 using the adapter connected to the adapter terminal 123, the switching control section 115 causes the switch 122a to switch to a state in which the contact terminal 116a is electrically connected to the adapter connected to the adapter terminal 123.

When the power source control section 138 charges the battery section 139 using the battery section 119, the switching control section 115 causes the switch 122b to switch to a state in which the contact terminal 116a is electrically connected to the battery section 119.

In addition, when the remaining battery level of the battery section 119 is compared with the remaining battery level of the battery section 139, the remaining battery level of the battery section 139 is lower than that of the battery section 119, and a battery charging operation is performed using the adapter connected to the adapter terminal 123, the control section 114 and the switching control section 115 can cause the switch 122c to switch to a state in which the battery section 119 is not electrically connected to the adapter terminal 123, and cause the switch 122a to switch to a state in which the contact terminal 116a is electrically connected to the adapter terminal 123. In this case, after the battery charging operation for the battery section 139 is completed, the control section 114 and the switching control section 115 cause the switch 122c to switch to a state in which the battery section 119 is electrically connected to the adapter terminal 123, and cause the switch 122a to switch to a state in which the contact terminal 116a is not electrically connected to the adapter terminal 123. Accordingly, when the remaining battery level of the battery section 119 is low, the battery charging operation in which the battery section 119 is charged is performed.

In addition, when the detection section 117b detects a voltage supplied from the contact terminal 116a, the switching control section 115 causes the switch 122b to switch to a state in which the battery section 119 is not electrically connected to the contact terminal 116a.

In addition, using the contact terminals 116b and 136b, the switching control section 115 detects whether the input operation section 110 and the information display section 130 are in the integrated state or in the mechanically separated state. When, on the basis of the contact terminals 116b and 136b, it is detected that the input operation section 110 and the information display section 130 are in the mechanically separated state, the switching control section 115 causes the switches 122a and 122b to switch to a state in which the adapter terminal 123 is not electrically connected to the contact terminal 116a and a state in which the battery section 119 is not electrically connected to the contact terminal 116a, respectively.

When the power source control section 118 charges the battery section 119 using the adapter connected to the adapter terminal 123, the switching control section 115 causes the switch 122a to switch to a state in which the contact terminal 116a is not electrically connected to the adapter connected to the adapter terminal 123.

The contact section 116 can be electrically connected to the contact section 136. The contact section 116 includes the contact terminals 116a, 116b, and 116c. In the contact section 116, the contact terminals 116a, 116b, and 116c are arranged so as to have contact with corresponding contact terminals in the contact section 136 when the input operation section 110 and the information display section 130 are in the integrated state. Accordingly, communication and power transfer may be performed between the input operation section 110 and the information display section 130.

The contact terminals 116a, 116b, and 116c are projected a little from the surface of the input operation section 110 so as to easily have contact with the contact terminals 136a and 136b and a contact terminal 136c in the contact section 136 included in the information display section 130, respectively. In addition, the peripheries of the contact terminals 116a, 116b, and 116c may be dented and the contact section 136 may be projected so that the contact section 116 mates with the contact section 136 and the contact terminals 116a, 116b, and 116c have contact with the contact terminals 136a, 136b, and 136c, respectively.

The contact terminal 116a is a contact terminal that can be connected to the contact terminal 136a and is used for supplying electric power by having contact with the information display section 130. The input operation section 110 supplies and receives charging power to and from the information display section 130 through the contact terminal 116a.

The contact terminal 116b is a contact terminal that can be connected to the contact terminal 136b and is used for detecting, by having contact with the information display section 130, whether the input operation section 110 and the information display section 130 are in the integrated state or in the mechanically separated state.

The contact terminal 116c is a contact terminal that can be connected to the contact terminal 136c and is used for performing contact communication with the information display section 130. The control section 114 transmits and receives communication data and a control signal to and from the control section 134 through the contact terminal 116c.

The detection section 117a detects a voltage supplied from the adapter connected to the adapter terminal 123. When the detection section 117a detects the voltage supplied from the adapter, the detection section 117a outputs the adapter voltage detection result to the control section 114 and the switching control section 115.

The detection section 117b detects a voltage supplied from the information display section 130 through the contact terminal 116a. When the detection section 117b detects the voltage supplied from the information display section 130 through the contact terminal 116a, the detection section 117b outputs the facing device voltage detection result to the switching control section 115.

The power source control section 118 controls a battery charging operation for the battery section 119, which uses electric power supplied from the adapter, connected to the adapter terminal 123, or the information display section 130. In addition, the power source control section 118 notifies the control section 114 of a remaining battery level notification that gives notice of the remaining battery level of the battery section 119. In addition, the power source control section 118 notifies the switching control section 115 of a charging status notification that indicates whether or not the battery section 119 is being charged.

In the case in which the battery section 119 is being charged, when the remaining battery level of the battery section 119 reaches a full charge level during a full charge operation, the power source control section 118 determines that the battery charging operation is completed.

In addition, in the case in which the battery section 119 is being charged, when the remaining battery level of the battery section 119 reaches a specified remaining battery level, which is lower than the remaining battery level of the battery section 139 at the time of full charge, the power source control section 118 may determine that the battery charging operation is completed. Accordingly, when the remaining battery level comes close to the full charge level, the control section 114 completes the battery charging operation for the battery section 119, and the battery section 139 begins charging. Therefore, a high electric charge effect can be obtained or maintained.

The battery section 119 includes the secondary battery that can be electrically connected to the contact terminal 116a. When there is no external power source, the input operation section 110 can also operate independently using electric power stored in the battery section 119.

The switch 122a may be used to set, in a switching manner, whether or not the adapter terminal 123 is electrically connected to the contact terminal 116a. When the switch 122a connects the adapter terminal 123 to the contact terminal 116a, electric power can be supplied from the adapter connected to the adapter terminal 123 to the information display section 130. In addition, when electric power is not supplied from the adapter connected to the adapter terminal 123 to the information display section 130, the switch 122a does not connect the adapter terminal 123 to the contact terminal 116a.

The switch 122b may be used to set, in a switching manner, whether or not the battery section 119 is electrically connected to the contact terminal 116a. When the switch 122b connects the battery section 119 to the contact terminal 116a, electric power can be supplied from the battery section 119 to the information display section 130. In addition, when electric power is not supplied from the battery section 119 to the information display section 130, the switch 122b does not connect the battery section 119 to the contact terminal 116a.

The switch 122c may be used to set, in a switching manner, whether or not the battery section 119 is electrically connected to the adapter terminal 123. Accordingly, the switch 122c can control whether or not the battery section 119 receives electronic power supplied from the adapter connected to the adapter terminal 123.

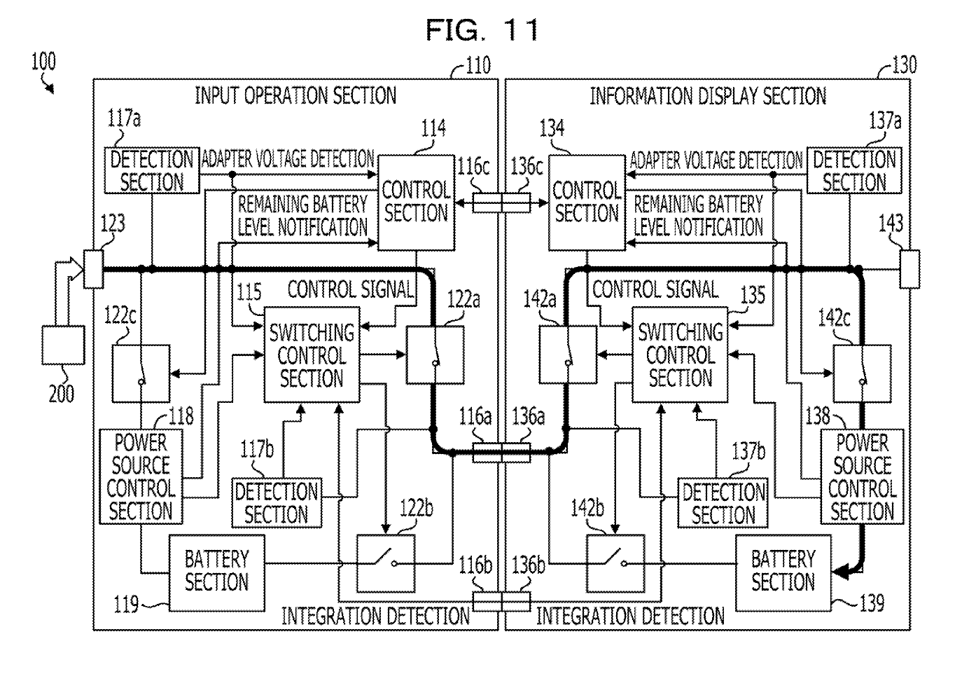

The adapter (for example, an adapter 200 described later with reference to FIG. 11) that is an external power source is configured to be connected to the adapter terminal 123. The adapter may be an adapter that converts commercial power supply to an electric current that the input operation section 110 can use and supplies the electric current, or may be an adapter that converts other power supply to an electric current that the input operation section 110 can use and supplies the electric current. In addition, the adapter terminal 123 may be able to receive electronic power supplied using a method, such as an external battery or the like, other than the adapter.

The control section 134 obtains signals transmitted from the control section 114, a detection section 137a, and the power source control section 138. In addition, by transmitting a control signal to the switching control section 135 on the basis of the obtained signals, the control section 134 causes the switching control section 135 to control switches 142a and 142b. In addition, the control section 134 controls a switch 142c on the basis of the obtained signals. The switching control section 135 controls the switches 142a and 142b on the basis of the control signal transmitted from the control section 114 and signals obtained from the detection section 137a, a detection section 137b, the power source control section 138, and the contact terminal 136b. The control section 134 and the switching control section 135 function as a switch control section.

When the adapter is connected to the adapter terminal 143 and the power source control section 118 charges the battery section 119 using the adapter, the switching control section 135 causes the switch 142a to switch to a state in which the contact terminal 136a is electrically connected to the adapter connected to the adapter terminal 143.

When the power source control section 118 charges the battery section 119 using the battery section 139, the switching control section 135 causes the switch 142b to switch to a state in which the contact terminal 136a is electrically connected to the battery section 139.

In addition, when the remaining battery level of the battery section 139 is compared with the remaining battery level of the battery section 119, the remaining battery level of the battery section 119 is lower than that of the battery section 139, and a battery charging operation is performed using the adapter connected to the adapter terminal 143, the control section 134 and the switching control section 135 may cause the switch 142c to switch to a state in which the battery section 139 is not electrically connected to the adapter terminal 143, and cause the switch 142a to switch to a state in which the contact terminal 136a is electrically connected to the adapter terminal 143. In this case, after the battery charging operation for the battery section 119 is completed, the control section 134 and the switching control section 135 cause the switch 142c to switch to a state in which the battery section 139 is electrically connected to the adapter terminal 143, and cause the switch 142a to switch to a state in which the contact terminal 136a is not electrically connected to the adapter terminal 143. Accordingly, when the remaining battery level of the battery section 139 is low, the battery charging operation in which the battery section 139 is charged may be performed.

When a battery charging operation, described later with reference to FIGS. 15 and 16, is performed, the control section 134 may determine the completion of the battery charging operation by comparing the remaining battery level of the battery section 139 with a specified voltage, which is lower than a remaining battery level at the time of full charge, on the basis of the detection of the remaining battery level of the battery section 139, performed by the power source control section 138. Accordingly, when the battery charging operation is performed, the battery section 119 and the battery section 139 may be effectively charged.

In addition, when the detection section 137b detects a voltage supplied from the contact terminal 136a, the switching control section 135 causes the switch 142b to switch to a state in which the battery section 139 is not electrically connected to the contact terminal 136a.

In addition, using the contact terminals 116b and 136b, the switching control section 135 detects whether the input operation section 110 and the information display section 130 are in the integrated state or in the mechanically separated state. When it is detected that the input operation section 110 and the information display section 130 are in the mechanically separated state on the basis of the contact terminals 116b and 136b, the switching control section 135 causes the switches 142a and 142b to switch to a state in which the adapter terminal 143 is not electrically connected to the contact terminal 136a and a state in which the battery section 139 is not electrically connected to the contact terminal 136a, respectively.

When the power source control section 138 charges the battery section 139 using the adapter connected to the adapter terminal 143, the switching control section 135 causes the switch 142a to switch to a state in which the contact terminal 136a is not electrically connected to the adapter connected to the adapter terminal 143.

The contact section 136 may be electrically connected to the contact section 116. The contact section 136 includes the contact terminals 136a, 136b, and 136c. In the contact section 136, the contact terminals 136a, 136b, and 136c are arranged so as to have contact with corresponding contact terminals in the contact section 116 when the input operation section 110 and the information display section 130 are in the integrated state. Accordingly, communication and power transfer may be performed between the information display section 130 and the input operation section 110.

The contact terminals 136a, 136b, and 136c are projected a little from the surface of the information display section 130 so as to easily have contact with the contact terminals 116a, 116b and 116c in the contact section 116 included in the input operation section 110, respectively. In addition, the peripheries of the contact terminals 136a, 136b, and 136c may be dented and the contact section 116 may be projected so that the contact section 136 mates with the contact section 116 and the contact terminals 136a, 136b, and 136c have contact with the contact terminals 116a, 116b, and 116c, respectively.

The contact terminal 136a is a contact terminal that may be connected to the contact terminal 116a and is used for supplying electric power by having contact with the input operation section 110. The information display section 130 supplies and receives charging power to and from the input operation section 110 through the contact terminal 136a.

The contact terminal 136b is a contact terminal that may be connected to the contact terminal 116b and is used for detecting, by having contact with the input operation section 110, whether the information display section 130 and the input operation section 110 are in the integrated state or in the mechanically separated state.

The contact terminal 136c is a contact terminal that may be connected to the contact terminal 116c and is used for performing contact communication with the input operation section 110. The control section 134 transmits and receives communication data and a control signal to and from the control section 114 through the contact terminal 136c.

The detection section 137a detects a voltage supplied from the adapter connected to the adapter terminal 143. When the detection section 137a detects the voltage supplied from the adapter connected to the adapter terminal 143, the detection section 137a outputs the adapter voltage detection result to the control section 134 and the switching control section 135.

The detection section 137b detects a voltage supplied from the input operation section 110 through the contact terminal 136a. When the detection section 137b detects the voltage supplied from the input operation section 110 through the contact terminal 136a, the detection section 137b outputs the facing device voltage detection result to the switching control section 135.

The power source control section 138 controls a battery charging operation for the battery section 139, which uses electric power supplied from the adapter, connected to the adapter terminal 143, or the input operation section 110. In addition, the power source control section 138 notifies the control section 134 of a remaining battery level notification that gives notice of the remaining battery level of the battery section 139. In addition, the power source control section 138 notifies the switching control section 135 of a charging status notification that indicates whether or not the battery section 139 is being charged.

In addition, in the case in which the battery section 139 is being charged, when the remaining battery level of the battery section 139 reaches a full charge level during a full charge operation, the power source control section 138 determines that the battery charging operation is completed.

In addition, in the case in which the battery section 139 is being charged, when the remaining battery level of the battery section 139 reaches a specified remaining battery level, which is lower than the remaining battery level of the battery section 139 at the time of full charge, the power source control section 138 may determine that the battery charging operation is completed. Accordingly, when the remaining battery level comes close to the full charge level, the control section 134 may complete the battery charging operation for the battery section 139, in order to instead charge the battery section 119. Therefore, a high electric charge effect may be obtained and/or maintained.

The battery section 139 includes the secondary battery that may be electrically connected to the contact terminal 136a. When there is no external power source, the information display section 130 can also operate independently using electric power stored in the battery section 139.

The switch 142a may be used to set, in a switching manner, whether or not the adapter terminal 143 is electrically connected to the contact terminal 136a. When the switch 142a connects the adapter terminal 143 to the contact terminal 136a, electric power may be supplied from the adapter connected to the adapter terminal 143 to the input operation section 110. In addition, when electric power is not supplied from the adapter connected to the adapter terminal 143 to the input operation section 110, the switch 142a does not connect the adapter terminal 143 to the contact terminal 136a.

The switch 142b may be used to set, in a switching manner, whether or not the battery section 139 is electrically connected to the contact terminal 136a. When the switch 142b connects the battery section 139 to the contact terminal 136a, electric power may be supplied from the battery section 139 to the input operation section 110. In addition, when electric power is not supplied from the battery section 139 to the input operation section 110, the switch 142b does not connect the battery section 139 to the contact terminal 136a.

The switch 142c may be used to set, in a switching manner, whether or not the battery section 139 is electrically connected to the adapter terminal 143. Accordingly, the switch 142c may control whether or not the battery section 139 receives electronic power supplied from the adapter connected to the adapter terminal 143.

The adapter that is an external power source is configured to be connected to the adapter terminal 143. The adapter may be an adapter that converts commercial power supply to an electric current that the information display section 130 may use and supplies the electric current, or may be an adapter that converts other power supply to an electric current that the information display section 130 may use and supplies the electric current. In addition, the adapter terminal 143 may be able to receive electronic power supplied using a method, such as an external battery or the like, other than the adapter. In addition, the adapter terminal 143 may be able to be connected to an adapter that can be connected to the adapter terminal 123, and may be used by being connected to a power source different from the adapter.

In addition, in the embodiment, the input operation section 110 includes the control section 114 and the switching control section 115, and the information display section 130 includes the control section 134 and the switching control section 135. However, the configuration is not limited to the example. The input operation section 110 may include a power source control device that includes the functions of the control section 114 and the switching control section 135, and the information display section 130 may include a power source control device that includes the functions of the control section 134 and the switching control section 135. In addition, by controlling the power sources in the input operation section 110 and the information display section 130, the power source control devices may realize the same functions as the control section 114, the switching control section 135, the control section 134, and the switching control section 135.

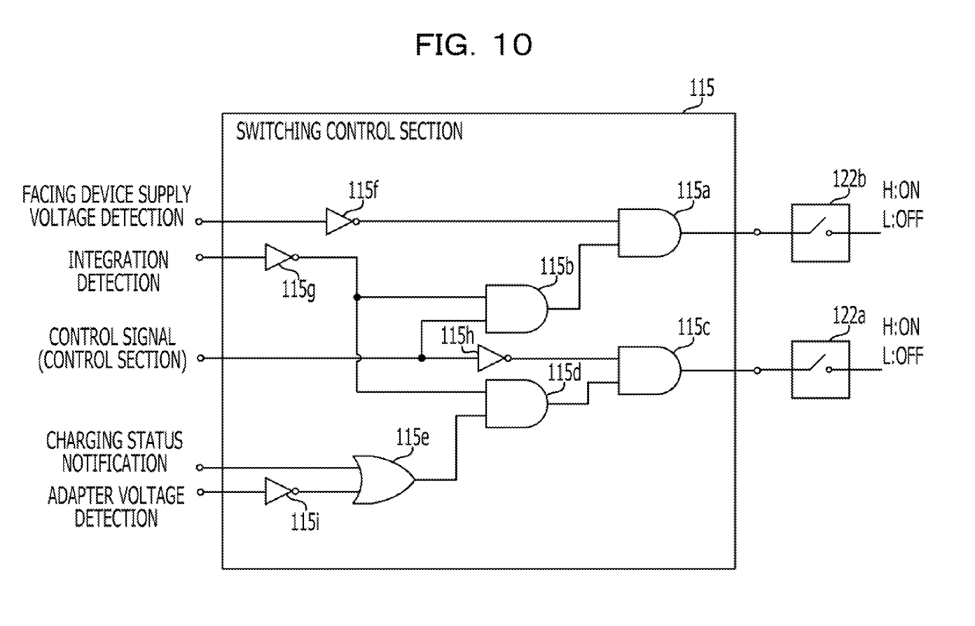

FIG. 10 illustrates a logic circuit for the switching control section according to the second embodiment. The switching control section 115 according to the second embodiment includes a logic circuit, which has positive logic, illustrated in FIG. 10. Here, while FIG. 10 illustrates the switching control section 115, the switching control section 135 has the same logic circuit.

The switching control section 115 includes AND circuits 115a, 115b, 115c, and 115d, an OR circuit 115e, NOT circuits 115f, 115g, 115h, and 115i, and the circuits are arranged as illustrated in FIG. 10. In addition, the switching control section 115 and input/output signals thereof are not limited to the logic circuit and signals illustrated in FIG. 10. As the switching control section 115 and the input/output signals, different logic circuit and different signals, which have the same functions, may be adopted.

The switching control section 115 receives, as input signals, a facing device supply voltage detection result from the detection section 117b, an integration detection result from the contact terminal 116b, a control signal from the control section 114, the charging status notification from the power source control section 118, and an adapter voltage detection result from the detection section 117a, and controls the switches 122a and 122b by outputting control signals to the switches 122a and 122b on the basis of the input signals.

The facing device supply voltage detection result is a signal transmitted from the detection section 117b. The facing device supply voltage detection result indicates whether or not a voltage supplied from the information display section 130 is detected. For example, when the voltage is detected, the facing device supply voltage detection result turns into a high-level signal, and when the voltage is not detected, the facing device supply voltage detection result turns into a low-level signal.

The integration detection result is a signal transmitted from the contact terminal 116b. The integration detection result indicates whether the input operation section 110 is separated from the information display section 130 or the input operation section 110 is integrated with the information display section 130. For example, when the input operation section 110 is separated from the information display section 130, the integration detection result turns into a high-level signal, and when the input operation section 110 is integrated with the information display section 130, the integration detection result turns into a low-level signal.

The control signal is a signal transmitted from the control section 114. The control signal indicates whether or not electric power is to be supplied from the battery section 119 to the information display section 130 through the contact terminal 116a in order to charge the battery section 139. For example, when electric power is to be supplied, the control signal turns into a high-level signal, and when electric power is not to be supplied, the control signal turns into a low-level signal.

The charging status notification is a signal transmitted from the power source control section 118. The charging status notification indicates whether or not the battery section 119 is currently charged. For example, when the battery section 119 is currently being charged, the charging status notification turns into a high-level signal, and when the battery section 119 is not currently being charged, the control signal turns into a low-level signal.

The adapter voltage detection result is a signal transmitted from the detection section 117a. The adapter voltage detection result indicates whether or not an adapter that externally supplies electric power is connected to the input operation section 110 through the adapter terminal 123. For example, when the adapter is connected, the adapter voltage detection result turns into a high-level signal, and when the adapter is not connected, the adapter voltage detection result turns into a low-level signal.

The switch 122a is a switch that is used to set, in a switching manner, whether or not the adapter terminal 123 is electrically connected to the contact terminal 116a. When a signal transmitted from the AND circuit 115c is a high-level signal, the switch 122a turns into an on-state, and when the signal transmitted from the AND circuit 115c is a low-level signal, the switch 122a turns into an off-state.

The switch 122b is a switch that is used to set, in a switching manner, whether or not the battery section 119 is electrically connected to the contact terminal 116a. When a signal transmitted from the AND circuit 115a is a high-level signal, the switch 122b turns into an on-state, and when the signal transmitted from the AND circuit 115a is a low-level signal, the switch 122b turns into an off-state.

In addition, the switching control section 135 controls the switches 122a and 122b so that the switches 122a and 122b do not simultaneously turn into the on-states. Accordingly, the adapter and the battery section 119 are inhibited or prevented from supplying electric power to the information display section 130 through the contact terminals 116a and 136a at the same time.

In addition, the switching control section 135 controls the switches 122a and 122b so that both the switches 122a and 122b turn into the off-states when the input operation section 110 is mechanically separated from the information display section 130. Accordingly, when the input operation section 110 and the information display section 130 are in the mechanically separated state, voltages supplied from the adapter and the battery section 119 are inhibited or prevented from being applied to the contact terminal 116a.

In addition, the switching control section 135 controls the switches 122a and 122b so that charging power is supplied from the adapter connected to the adapter terminal 123 to one of the input operation section 110 and the information display section 130. Accordingly, the adapter is inhibited or prevented from becoming overloaded in case of charge, and an excessive electric current is prevented from flowing in the mobile terminal device 100.

FIG. 11 illustrates a processing operation performed when the input operation section and the information display section are charged using the adapter connected to the input operation section according to the second embodiment. In the embodiment, when an adapter terminal arranged in one of the input operation section 110 and the information display section 130 included in the mobile terminal device 100, charging power is supplied. For example, when the adapter terminal 123 is arranged in the input operation section 110, is connected to the adapter 200 that supplies charging power, the battery sections 119 and 139 can be charged through the input operation section 110.

As illustrated in FIG. 11, the adapter 200 is connected to the adapter terminal 123 arranged in the input operation section 110. FIG. 11 illustrates the mobile terminal device 100 in which the battery section 139 is being charged after a battery charging operation for the battery section 119, performed by the adapter 200, has been completed. In addition, an adapter is not connected to the adapter terminal 143 arranged in the information display section 130.

The contact terminals 116a, 116b, and 116c are connected to the contact terminals 136a, 136b, and 136c, respectively. Using the connection between the contact terminals 116a and 136a, the input operation section 110 and the information display section 130 can supply charging power to each other. Using the connection between the contact terminals 116b and 136b, the switching control sections 115 and 135 detect the integration of the input operation section 110 and the information display section 130. Using the connection between the contact terminals 116c and 136c, the control section 114 can transmit and receive control signals to and from the control section 134.

The detection section 117a detects the voltage of the adapter 200 connected to the adapter terminal 123, and outputs the adapter voltage detection result to the control section 114 and the switching control section 115 (e.g., a high-level signal may be output to the control section 114 and the switching control section 115). Since the detection section 117b does not detect a voltage supplied from the information display section 130 side, the detection section 117b does not output a facing device voltage detection result (e.g., a low-level signal is output). Since an adapter is not connected to the adapter terminal 143, and hence the detection section 137a does not detect the voltage of an adapter, the detection section 137a does not output an adapter voltage detection result. Since the detection section 137b does not detect a voltage supplied from the input operation section 110, during the battery charging operation for the battery section 119, performed by the adapter 200, the detection section 137b does not output the facing device voltage detection result. However, after that, the detection section 137b detects the voltage of the adapter 200 connected to the input operation section 110, during the battery charging operation for the battery section 139, and hence the detection section 137b outputs the facing device voltage detection result to the switching control section 135.

The power source control section 118 does not output the charging status notification while the adapter 200 is charging the battery section 119. In addition, the power source control section 118 detects the completion of the battery charging operation for the battery section 119. In addition, since the battery section 119 is not being charged after the completion of the battery charging operation for the battery section 119, the power source control section 118 outputs the charging status notification to the switching control section 115. In addition, the power source control section 118 notifies the control section 114 of a notification relating to the remaining battery level of the battery section 119.

The power source control section 138 does not output the charging status notification while the adapter 200 is charging the battery section 139. In addition, the power source control section 138 detects the completion of the battery charging operation for the battery section 139. In addition, since the battery section 139 is not being charged after the completion of the battery charging operation for the battery section 139, the power source control section 138 outputs the charging status notification to the switching control section 135. In addition, the power source control section 138 notifies the control section 134 of a notification relating to the remaining battery level of the battery section 139.

While the adapter 200 is charging the battery section 119, the control section 114 controls the switch 122c so that the switch 122c is in an on-state. After that, while the adapter 200 is charging the battery section 139, the control section 114 controls the switch 122c so that the switch 122c is in the on-state, as illustrated in FIG. 11.

While the adapter 200 is charging the battery section 119, the switching control section 115 controls the switches 122a and 122b so that the switches 122a and 122b are in the off-states. After that, while the adapter 200 is charging the battery section 139, the switching control section 115 controls the switches 122a and 122b that the switch 122a is in the on-state and the switch 122b is in the off-state, as illustrated in FIG. 11.

While the adapter 200 is charging the battery section 119, the control section 134 controls the switches 142c so that the switches 142c is in an on-state. After that, while the adapter 200 is charging the battery section 139, the control section 134 controls the switch 142c so that the switch 142c is in the on-state, as illustrated in FIG. 11.

While the adapter 200 is charging the battery section 119, the switching control section 135 controls the switches 142a and 142b so that the switches 142a and 142b are in the off-states. After that, while the adapter 200 is charging the battery section 139, the switching control section 135 controls the switches 142a and 142b so that the switch 142a is in an on-state and the switch 142b is in an off-state, as illustrated in FIG. 11.

While the adapter 200 is charging the battery section 119, the switching control section 115 controls the switch 122a so that the switch 122a is in the off-state. The switching control section 115 controls the switch 122b so that the switch 122b is in the off-state. The control section 114 controls the switch 122c so that the switch 122c is in the on-state. The switching control section 135 controls the switch 142a so that the switch 142a is in an off-state. The switching control section 135 controls the switch 142b so that the switch 142b is in the off-state. The control section 134 controls the switch 142c so that the switch 142c is in the on-state. Accordingly, while the battery section 119 is being charged, the electric power of the adapter 200 connected to the adapter terminal 123 is supplied to the battery section 119 through the switch 122c and the power source control section 118. In addition, while the battery section 119 is being charged, by putting the switch 122b into the off-state, a countercurrent and a short circuit are prevented from occurring and the safety is ensured.

While the battery section 139 is being charged, the switching control section 115 controls the switch 122a so that the switch 122a is in the on-state, as illustrated in FIG. 11. The switching control section 115 controls the switch 122b so that the switch 122b is in the off-state. The control section 114 controls the switch 122c so that the switch 122c is in the on-state. The switching control section 135 controls the switch 142a so that the switch 142a is in the on-state. The switching control section 135 controls the switch 142b so that the switch 142b is in the off-state. The control section 134 controls the switch 142c so that the switch 142c is in the on-state. Accordingly, while the battery section 139 is being charged, the electric power of the adapter 200 connected to the adapter terminal 123 is supplied to the battery section 139 through the switch 122a, the contact terminals 116a and 136a, the switches 142a and 142c, and the power source control section 138. In addition, while the battery section 139 is being charged, by putting the switch 142b into the off-state, a countercurrent and a short circuit are inhibited or prevented from occurring and the safety is ensured.

Here, the charging status notifications that the power source control sections 118 and 138 provide may be given constantly or periodically, for example. In addition, the charging status notifications may be provided in response to requests from the control sections 114 and 134.

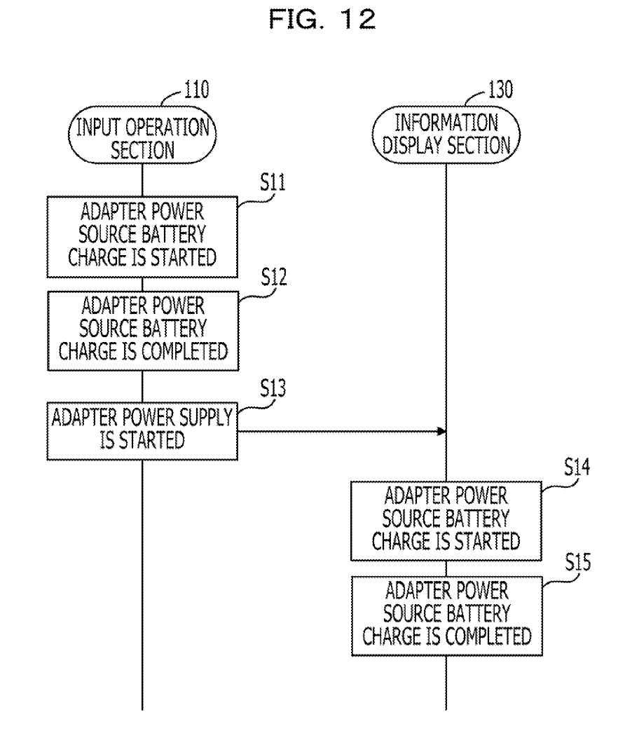

FIG. 12 illustrates the flow of a processing operation performed when the input operation section and the information display section are charged using the adapter connected to the input operation section according to the second embodiment. The processing operation illustrated in FIG. 12 will be described in line with the step numbers of the sequence diagram, hereinafter. The execution of the following processing operation is started when one device connected to an adapter charges the device and a facing device. Here, while a case in which the input operation section 110 is connected to the adapter 200 will be described, a case in which the information display section 130 is connected to the adapter 200 is the same as the former case, and hence the descriptions thereof will be omitted.

[Step S11] The control section 114 starts charging the battery section 119 by using the adapter 200. At this time, the control section 114 causes the switching control section 115 to control the switch 122a so that the switch 122a is in the off-state. In addition, the control section 114 controls the switch 122c so that the switch 122c is in the on-state.

[Step S12] When the battery charging operation for the battery section 119 is completed, the power source control section 118 switches a signal used for the charging status notification and notifies the switching control section 115 of the completion of the battery charging operation. In addition, by using the remaining battery level notification, the power source control section 118 notifies the control section 114 of the completion of the battery charging operation. When the switching control section 115 detects the charging status notification, the switching control section 115 controls the switch 122a so that the switch 122a is in the on-state.

[Step S13] The control section 114 controls the switching control section 115 to start supplying charging power for the battery section 139 by using the adapter 200 as a power source. At this time, the control section 114 causes the switching control section 115 to control the switches 122a and 122b so that the switch 122a is in the on-state and the switch 122b is in the off-state. In addition, the control section 114 controls the switch 122c so that the switch 122c is in the on-state. In addition, through the contact terminals 116c and 136c, the control section 114 notifies the control section 134 of the start of the supply of electric power which uses the adapter 200 as a power source.

[Step S14] The control section 134 controls the power source control section 138 to start charging the battery section 139 by using the adapter 200 as a power source. At this time, the control section 134 causes the switching control section 135 to control the switch 142a so that the switch 142a is in the on-state. In addition, the control section 134 controls the switch 142c so that the switch 142c is in the on-state.

[Step S15] When the battery charging operation for the battery section 139 is completed, the power source control section 138 switches a signal used for the charging status notification and notifies the switching control section 135 of the completion of the battery charging operation. In addition, by using the remaining battery level notification, the power source control section 138 notifies the control section 134 of the completion of the battery charging operation.

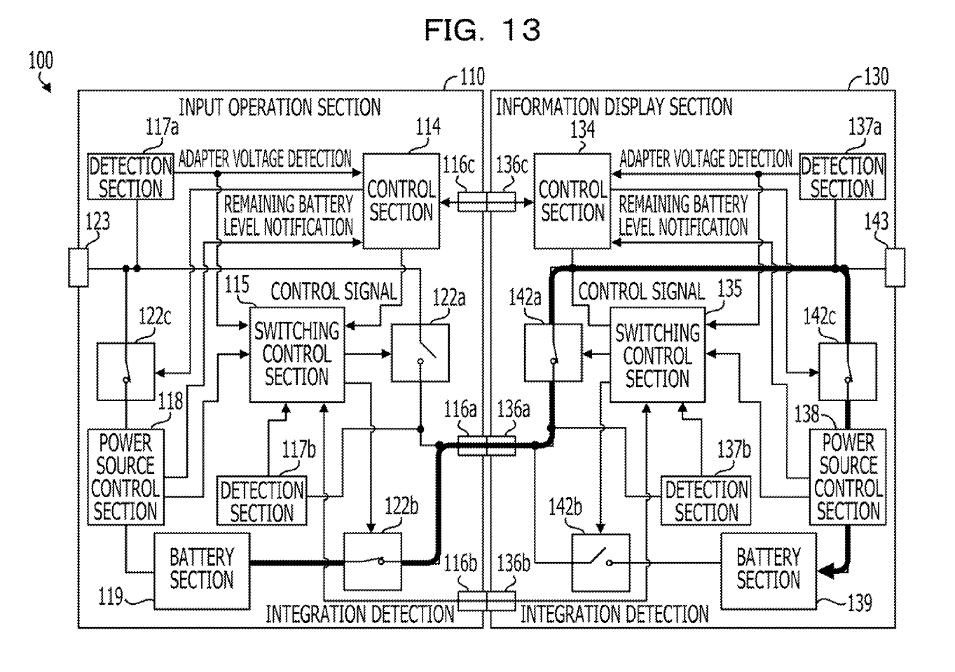

FIG. 13 illustrates a battery power supply processing operation according to the second embodiment. In the embodiment, a battery power supply processing operation, in which, using the remaining battery charge of one (for example, the input operation section 110) of the input operation section 110 and the information display section 130 included in the mobile terminal device 100, the other device is charged, may be performed.

FIG. 13 illustrates the mobile terminal device 100 in which the battery section 139 included in the information display section 130 is being charged using the remaining battery charge of the battery section 119 included the input operation section 110. In addition, at this time, neither the adapter terminal 123 included in the input operation section 110 nor the adapter terminal 143 included in the information display section 130 is connected to an adapter.

As described above, the contact terminals 116a, 116b, and 116c are connected to the contact terminals 136a, 136b, and 136c, respectively. Since neither of adapters is connected, and hence neither of the detection sections 117a and 137a detects the voltages of an adapter, neither of the detection sections 117a and 137a outputs an adapter voltage detection result. Since the detection section 117b does not detect a voltage supplied from the information display section 130, the detection section 117b does not output a facing device voltage detection result. Since the detection section 137b detects the voltage of the battery section 119, the detection section 137b outputs a facing device voltage detection result to the switching control section 135.

The power source control section 118 notifies the control section 114 of a notification relating to the remaining battery level of the battery section 119. The power source control section 138 does not output the charging status notification while the battery section 139 is being charged. In addition, the power source control section 138 detects the completion of the battery charging operation for the battery section 139. In addition, after the completion of the battery charging operation for the battery section 139, the power source control section 138 outputs the charging status notification to the switching control section 135. In addition, the power source control section 138 notifies the control section 134 of a notification relating to the remaining battery level of the battery section 139.

While the battery section 119 is charging the battery section 139, the control section 114 controls the switch 122c so that the switch 122c is in the on-state, as illustrated in FIG. 13. The switching control section 115 controls the switches 122a and 122b so that the switch 122a is in the off-state and the switch 122b is in the on-state. The control section 134 controls the switch 142c so that the switch 142c is in the on-state. The switching control section 135 controls the switches 142a and 142b so that the switch 142a is in the on-state and the switch 142b is in the off-state.

While the battery section 119 is charging the battery section 139, the switching control section 115 controls the switch 122a so that the switch 122a is in the off-state, as illustrated in FIG. 13. The switching control section 115 controls the switch 122b so that the switch 122b is in the off-state. The control section 114 controls the switch 122c so that the switch 122c is in the on-state. The switching control section 135 controls the switch 142a so that the switch 142a is in the on-state. The switching control section 135 controls the switch 142b so that the switch 142b is in the off-state. The control section 134 controls the switch 142c so that the switch 142c is in the on-state. Accordingly, while the battery section 119 is charging the battery section 139, the electric power of the battery section 119 is supplied to the battery section 139 through the switch 122b, the contact terminals 116a and 136a, the switches 142a and 142c, and the power source control section 138. In addition, while the battery section 119 is charging the battery section 139, by putting the switch 142b into the off-state, a countercurrent and a short circuit are inhibited or prevented from occurring and the safety is ensured.

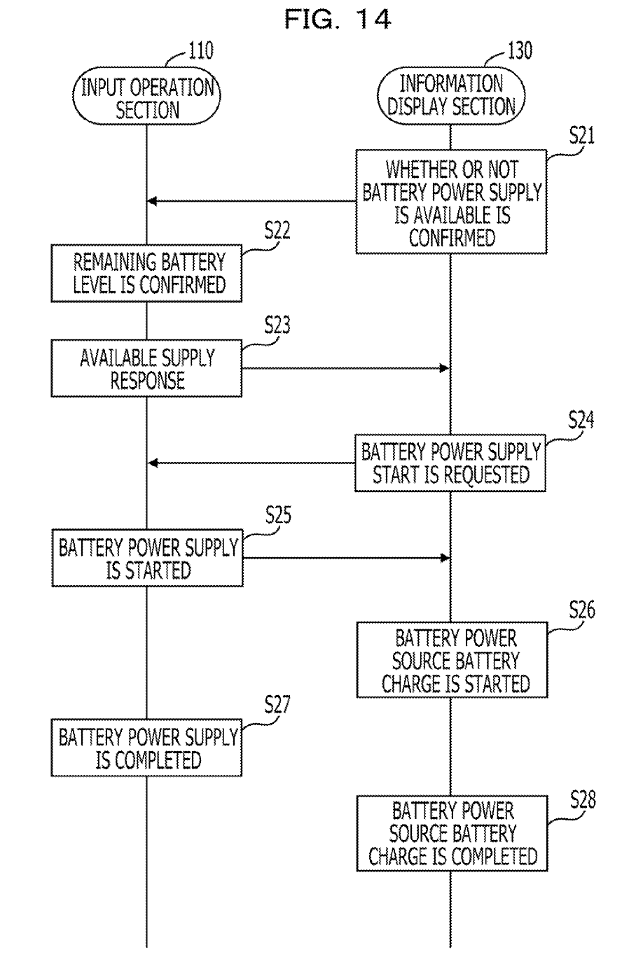

FIG. 14 illustrates the flow of the battery power supply processing operation according to the second embodiment. The processing operation illustrated in FIG. 14 will be described in line with the step numbers of the sequence diagram, hereinafter. The execution of the following processing operation is started when the remaining battery level of the other device falls. Here, while a case in which the remaining battery level of the input operation section 110 has room for use and the remaining battery level of the information display section 130 falls will be described, a case in which the remaining battery level of the information display section 130 has room for use and the remaining battery level of the input operation section 110 falls is the same as the former case, and hence the descriptions thereof will be omitted.

[Step S21] The control section 134 transmits a notification to the control section 114 through the contact terminals 136c and 116c, the notification being used for confirming whether or not the information display section 130 can receive a supply of charging power, using the remaining battery charge of the battery section 119 as a power source, so as to charge the battery section 139.

Here, regarding whether or not to confirm the supply of charging power from the battery section 119 for the battery section 139, for example, when a charging rate, which is the ratio of a currently remaining battery level to the remaining battery level of the battery section 139 at the time of full charge, is less than a specified ratio (for example, 25%), with respect to the remaining battery level of the battery section 139, the supply of charging power may be confirmed. In addition, it may be determined whether or not to confirm the supply of charging power, using another criterion.

As an example of the specified ratio, a threshold value used for a remaining battery level display shown in the information display section 130 may be used. Here, in the input operation section 110 and the information display section 130 according to the embodiment, it may be assumed that remaining battery level are displayed to indicate the individual remaining battery levels. In each of the devices that are the input operation section 110 and the information display section 130, a remaining battery level display corresponding to the remaining battery level of the device (for example, a display where vertically long bars are horizontally aligned the number of which changes to any integer from among “zero” to “three”) is performed.

For example, when the remaining battery level is more than or equal to 70% of the remaining battery level at the time of full charge, “three bars”, the maximum number of bars, are displayed on the remaining battery level display. When the remaining battery level is more than or equal to 20% of but less than 70% of the remaining battery level at the time of full charge, “two bars” are displayed on the remaining battery level display. When the remaining battery level is more than or equal to 10% of but less than 20% of the remaining battery level at the time of full charge, “one bar” is displayed on the remaining battery level display. When the remaining battery level is less than 10% of the remaining battery level at the time of full charge, “no bar” is displayed on the remaining battery level display.

In such a case, when the remaining battery level of the battery section 139 in the information display section 130 is lower than “10%”, which is the lower threshold value adopted when “one bar” is displayed on the remaining battery level display, the information display section 130 may confirm with the input operation section 110 the supply of charging power from the battery section 119.

[Step S22] On the basis of the notification relating to the remaining battery level, which the power source control section 118 provides, the control section 114 confirms the remaining level of the battery section 119. If the remaining level of the battery section 119 is not enough to supply electric power to the battery section 139, the control section 114 transmits an unavailable supply response, which indicates that the supply of electric power is not available. The supply response is provided to the control section 134 through the contact terminals 116c and 136c. When the remaining battery level is enough to supply electric power to the battery section 139, the processing operation can proceed to Step S23.

Regarding whether or not the remaining battery level of the battery section 119 is enough to supply electric power to the battery section 139, for example, when a charging rate, which is the ratio of a current remaining battery level to the remaining battery level of the battery section 119 at the time of full charge, is more than or equal to a specified ratio (for example, 50%), with respect to the remaining battery level of the battery section 119, it is determined that the remaining battery level of the battery section 119 is enough to supply electric power to the battery section 139. In addition, it may be determined whether or not the remaining battery level of the battery section 119 is enough, using another criterion.

As an example of the specified ratio, in the same way as Step S21, a threshold value used for a remaining battery level display shown in the input operation section 110 may be used. For example, when the information display section 130 confirms with the input operation section 110 the supply of charging power from the battery section 119 to the battery section 139, the control section 114 may determine whether or not the supply of charging power is performed, on the basis of whether the remaining battery level of the battery section 119 in the input operation section 110 is more than or equal to, or less than “70%”, which is the lower threshold value adopted when “three bars” are displayed on the remaining battery level display. At this time, when the remaining battery level of the battery section 119 is more than or equal “70%”, the control section 114 may perform the supply of charging power from the battery section 119, and when the remaining battery level of the battery section 119 is less than “70%”, the control section 114 may not perform the supply of charging power from the battery section 119.

[Step S23] The control section 114 transmits an available supply response, which indicates that electric power can be supplied using the battery section 119, through the contact terminals 116c and 136c.

[Step S24] The control section 134 transmits to the control section 114 through the contact terminals 136c and 116c a request relating to the start of the supply of charging power performed using the remaining battery charge of the battery section 119 as a power source.

[Step S25] The control section 114 controls the switching control section 115 to start supplying charging power for the battery section 139 by using the battery section 119 as a power source. At this time, the control section 114 causes the switching control section 115 to control the switches 122a and 122b so that the switches 122a is in the off-state and the switches 122b is in the on-state. In addition, the control section 114 controls the switch 122c so that the switch 122c is in the on-state. In addition, through the contact terminals 116c and 136c, the control section 114 notifies the control section 134 of the start of the supply of charging power performed using the battery section 119 as a power source.

[Step S26] The control section 134 controls the power source control section 138 to start charging the battery section 139 by using the battery section 119 as a power source. At this time, by transmitting a control signal to the switching control section 135, the control section 134 causes the switching control section 135 to control the switches 142a and 142b so that the switch 142a is in the on-state and the switch 142b is in the off-state. In addition, the control section 134 controls the switch 142c so that the switch 142c is in the on-state.

[Step S27] The control section 114 monitors the remaining battery level notification provided by the power source control section 118, which indicates the remaining battery level of the battery section 119. In addition, when the remaining battery level of the battery section 119 becomes lower than a specified level, the control section 114 terminates the supply of charging power, performed using the battery section 119 as a power source. In this case, the control section 114 switches the control signal and notifies the switching control section 135 of the completion of the battery charging operation. In addition, through the contact terminals 116c and 136c, the control section 114 transmits a notification relating to the completion of the supply of charging power performed using the battery section 119 as a power source.

[Step S28] When the battery charging operation for the battery section 139 is completed, the power source control section 138 switches a signal used for the charging status notification and notifies the switching control section 135 of the completion of the battery charging operation. In addition, in the battery power supply processing operation according to the embodiment, on the basis of whether or not the remaining battery level of the battery section 119 is enough to supply electric power to the battery section 139, it is determined whether or not the battery power supply is performed. However, the determination operation is not limited to the example but the determination may be performed using another determination criterion such as the comparison of the remaining battery level of the battery section 119 with the remaining battery level of the battery section 139, or the like.

In addition, in the embodiment, for example, when the remaining battery level of the battery section 119 becomes lower than a specified level, the battery power supply for the battery section 139 is terminated. However, the termination of the battery power supply is not limited to the example but, for example, the termination may be performed using another determination criterion such as the case in which, when the remaining battery level of the battery section 119 becomes equal to the remaining battery level of the battery section 139, the battery power supply is terminated, or the like.

FIG. 15 illustrates a processing operation for battery charging according to the second embodiment. In the embodiment, when, using an adapter terminal arranged in one of the input operation section 110 and the information display section 130 included in the mobile terminal device 100 (e.g., the adapter terminal 123 arranged in the input operation section 110), the battery sections 119 and 139 are charged. Further, example embodiments also include a battery charging operation where one device, the remaining battery level of which is less than that of the other device, is charged.

As illustrated in FIG. 15, the adapter 200 is connected to the adapter terminal 123 in the input operation section 110. FIG. 15 illustrates the mobile terminal device 100 in which the battery section 139 is charged using the adapter 200. In addition, an adapter is not connected to the adapter terminal 143 in the information display section 130.

As described above, the contact terminals 116a, 116b, and 116c are connected to the contact terminals 136a, 136b, and 136c, respectively. The detection section 117a detects the voltage of the adapter 200 connected to the adapter terminal 123, and outputs the adapter voltage detection result to the control section 114 and the switching control section 115. Since the detection section 117b does not detect a voltage supplied from the information display section 130 side, the detection section 117b does not output a facing device voltage detection result. Since an adapter is not connected to the adapter terminal 143, and hence the detection section 137a does not detect the voltage of an adapter, the detection section 137a does not output an adapter voltage detection result. While the detection section 137b detects the voltage of the adapter 200, connected to the input operation section 110, during the preferential battery charging operation for the battery section 139, the detection section 137b outputs the facing device voltage detection result to the switching control section 13. However, after that, since the detection section 137b does not detect a voltage supplied from the input operation section 110, during the battery charging operation for the battery section 119, the detection section 137b does not output the facing device voltage detection result.

Since the battery section 119 is not being charged during the battery charging operation for the battery section 139, performed by the adapter 200, the power source control section 118 outputs the charging status notification to the switching control section 115. In addition, after that, the power source control section 118 does not output the charging status notification while the battery section 119 is being charged. In addition, the power source control section 118 notifies the control section 114 of a notification relating to the remaining battery level of the battery section 119.

The power source control section 138 does not output the charging status notification while the adapter 200 is charging the battery section 139. In addition, when the battery charging operation for the battery section 139 is completed, the power source control section 138 detects the completion of the battery charging operation for the battery section 139. In addition, since the battery section 139 is not being charged while the battery section 119 is being charged, the power source control section 138 outputs the charging status notification to the switching control section 135. In addition, the power source control section 138 notifies the control section 134 of a notification relating to the remaining battery level of the battery section 139.

While the adapter 200 is charging the battery section 139, the control section 114 controls the switch 122c so that the switch 122c is in the off-state, as illustrated in FIG. 15. After that, while the adapter 200 is charging the battery section 119, the control section 114 controls the switch 122c so that the switch 122c is in the on-state.

While the adapter 200 is charging the battery section 139, the switching control section 115 controls the switches 122a and 122b so that the switch 122a is in the on-states and the switch 122b is in the off-states, as illustrated in FIG. 15. After that, while the adapter 200 is charging the battery section 119, the switching control section 115 controls the switches 122a and 122b that the switches 122a and 122b are in the off-state.

While the adapter 200 is charging the battery section 139, the control section 134 controls the switches 142c so that the switches 142c is in the on-state, as illustrated in FIG. 15. While the adapter 200 is charging the battery section 119 after the power source control section 138 detects the completion of the battery charging operation for the battery section 139, the control section 134 controls the switch 142c so that the switch 142c is in the on-state.

While the adapter 200 is charging the battery section 139, the switching control section 135 controls the switches 142a and 142b so that the switch 142a is in the on-state and the switch 142b is in the off-state, as illustrated in FIG. 15. After that, while the adapter 200 is charging the battery section 119, the switching control section 135 controls the switches 142a and 142b so that the switches 142a and 142b are in the off-states.

While the adapter 200 is charging the battery section 139, the switching control section 115 controls the switch 122a so that the switch 122a is in the on-state, as illustrated in FIG. 15. The switching control section 115 controls the switch 122b so that the switch 122b is in the off-state. The control section 114 controls the switch 122c so that the switch 122c is in the off-state. The switching control section 135 controls the switch 142a so that the switch 142a is in the on-state. The switching control section 135 controls the switch 142b so that the switch 142b is in the off-state. The control section 134 controls the switch 142c so that the switch 142c is in the on-state. Accordingly, while the battery section 139 is being charged, the electric power of the adapter 200 connected to the adapter terminal 123 is supplied to the battery section 139 through the switch 122a, the contact terminals 116a and 136a, the switches 142a and 142c, and the power source control section 138. In addition, while the battery section 139 is being charged, by putting the switch 142b into the off-state, a countercurrent and a short circuit are inhibited or prevented from occurring and the safety is ensured. In addition, even though the remaining battery level of the battery section 119 is not enough, by putting the switch 122c into the off-state while the battery section 139 is being charged, an electric current between the adapter 200 and the battery section 119 is shut off, and the electric power of the adapter 200 is supplied to the battery section 139.

While the battery section 119 is being charged, the switching control section 115 controls the switch 122a so that the switch 122a is in the off-state. The switching control section 115 controls the switch 122b so that the switch 122b is in the off-state. The control section 114 controls the switch 122c so that the switch 122c is in the on-state. The switching control section 135 controls the switch 142a so that the switch 142a is in the off-state. The switching control section 135 controls the switch 142b so that the switch 142b is in the off-state. The control section 134 controls the switch 142c so that the switch 142c is in the on-state. Accordingly, while the battery section 119 is being charged, the electric power of the adapter 200 connected to the adapter terminal 123 is supplied to the battery section 119 through the switch 122c and the power source control section 118. In addition, while the battery section 119 is being charged, by putting the switch 122b into the off-state, a countercurrent and a short circuit are inhibited or prevented from occurring and the safety is ensured.

FIG. 16 illustrates the flow of the processing operation for battery charging according to the second embodiment. The processing operation illustrated in FIG. 16 will be described in line with the step numbers of the sequence diagram, hereinafter. The execution of the following processing operation is started when one device connected to an adapter charges the device and a facing device and the remaining battery level of the facing device falls. Here, while a case in which the adapter 200 is connected to the input operation section 110 and the remaining battery level of the information display section 130 falls will be described, a case in which an adapter is connected to the information display section 130 and the remaining battery level of the input operation section 110 falls is the same as the former case, and hence the descriptions thereof will be omitted.

[Step S31] The control section 134 transmits a battery charge request to the control section 114 through the contact terminals 136c and 116c, the battery charge request being used for requesting to charge the battery section 139 using the adapter 200, connected to the adapter terminal 123, as a power source. In addition, the battery charge request includes information indicating the remaining battery level of the battery section 139.

[Step S32] On the basis of the information indicating the remaining battery level of the battery section 139, included in the battery charge request that the control section 134 gives notice of, the control section 114 confirms the remaining level of the battery section 139. In addition, on the basis of the notification relating to the remaining battery level, which the power source control section 118 gives notice of, the control section 114 confirms the remaining level of the battery section 119. Next, when, by comparing the remaining battery level of the battery section 119 with the remaining battery level of the battery section 139, it is determined that the remaining battery level of the battery section 139 is greater than or equal to that of the battery section 119, the control section 114 transmits an unavailable battery charge supply response, which indicates that the preferential battery charging operation is not available, to the control section 134 through the contact terminals 116c and 136c while the control section 114 does not perform the preferential battery charging operation. After that, as illustrated in FIGS. 11 and 12, in the mobile terminal device 100, after the battery section 119 is charged first, the battery section 139 is charged. When the remaining battery level of the battery section 139 is low, the processing operation proceeds to Step S33.

[Step S33] The control section 114 controls the switching control section 115 to start supplying charging power for the battery section 139 by using the adapter 200 as a power source. At this time, the control section 114 causes the switching control section 115 to control the switches 122a and 122b so that the switch 122a is in the on-state and the switch 122b is in the off-state. In addition, the control section 114 controls the switch 122c so that the switch 122c is in the off-state. In addition, through the contact terminals 116c and 136c, the control section 114 notifies the control section 134 of the start of the battery charging operation that uses the adapter 200 as a power source.

[Step S34] The control section 134 controls the power source control section 138 to start charging the battery section 139 by using the adapter 200 as a power source. At this time, the control section 134 causes the switching control section 135 to control the switch 142a so that the switch 142a is in the on-state. In addition, the control section 134 controls the switch 142c so that the switch 142c is in the on-state.

[Step S35] When the battery charging operation for the battery section 139 is completed, the power source control section 138 switches a signal used for the charging status notification and notifies the switching control section 135 of the completion of the battery charging operation. In addition, by using the remaining battery level notification, the power source control section 138 notifies the control section 134 of the completion of the battery charging operation.

Here, regarding the determination of whether or not the battery charging operation for the battery section 139 is completed, when the remaining battery level of the battery section 139 reaches a specified remaining battery level (for example, a remaining battery level corresponding to 80% of the remaining battery level of the battery section 139 at the time of full charge), the power source control section 138 may determine that the battery charging operation for the battery section 139 is completed. The charge efficiencies of some batteries decrease when the remaining battery levels thereof approach full charge levels to some extent (for example, more than or equal to 70% of full charge levels thereof). On the basis of the fact, when the remaining battery level does not reach the full charge level but reaches a specified remaining battery level (for example, 80% of the full charge level), a high electric charge effect can be obtained by completing the battery charging operation for the battery section 139 and charging the battery section 119.

[Step S36] The control section 134 transmits a battery charge completion notification to the control section 114 through the contact terminals 136c and 116c, the battery charge completion notification being used for giving notice of the completion of the battery charging operation for the battery section 139.

[Step S37] The control section 114 starts charging the battery section 119 by using the adapter 200 as a power source. At this time, the control section 114 causes the switching control section 115 to control the switch 122a so that the switch 122a is in the off-state. In addition, the control section 114 controls the switch 122c so that the switch 122c is in the on-state.

[Step S38] When the battery charging operation for the battery section 119 is completed, the power source control section 118 switches a signal used for the charging status notification and notifies the switching control section 115 of the completion of the battery charging operation. In addition, by using the remaining battery level notification, the power source control section 118 notifies the control section 114 of the completion of the battery charging operation.

In addition, in the battery charging operation according to the embodiment, for example, by comparing the remaining battery level of the battery section 119 with the remaining battery level of the battery section 139, it is determined whether or not the battery charging operation is performed. However, the determination operation is not limited to the example but the determination may be performed using another determination criterion such as the comparison of the charging rate of the battery section 119 with the charging rate of the battery section 139, or the like.

As described above, according to the second embodiment, the individual remaining battery levels of the separable input operation section 110 and the separable information display section 130, arranged in the mobile terminal device 100, can be adjusted between both devices.

In addition, if one device is connected to an adapter, the other device can also be charged. Therefore, the time and effort of the user can be simplified when a battery charging operation is performed. In addition, by connecting the adapter to one of the input operation section 110 and the information display section 130, which are in the integrated state, both devices can be charged.

In addition, for example, in the case in which, using battery power, the user uses the mobile terminal device 100 in the mechanically separated state, at the time that a battery in one device has been drained first, such as the case in which the device is mainly used, or the like, if a battery in the other device has some energy left, by using the remaining battery charge of the battery that has some energy left, the battery in the device that has been drained can be charged. Accordingly, the operation time of the device, the battery of which has been drained, can be extended, and the battery operation time of the entire mobile terminal device 100 can be lengthened.

In addition, in the case in which the input operation section 110 and the information display section 130, which are in the integrated state, are charged using the adapter, when there is an imbalance between the remaining battery levels of both devices, one device, the remaining battery level of which is lower, can be charged.

In addition, since a connection line is shared through which the devices supply electric power to each other, contacts and connection lines arranged between the input operation section 110 and the information display section 130 in the mobile terminal device 100 can be simplified. Here, while the embodiment is described by citing the mobile terminal device, the mobile terminal device is just an example, and the techniques described in the embodiment can be applied to all kinds of separable electronic devices. Examples of the electronic devices that the techniques can be applied to include a mobile phone, a portable TV terminal, a portable video game player, an electronic dictionary device, a notebook computer, and PDA or the like, which can be individually separated into main bodies and cradles. However, Examples of the electronic devices are not limited to these devices mentioned above.

In addition, for example, the cradle may include a function used for charging the main body, a function used for reading and writing information from and into the main body by communicating with the main body, and a function used for displaying the information read out. As mentioned above, the disclosed electronic devices and the disclosed power source control devices are described on the basis of the embodiment illustrated. However, the above descriptions are just for presenting the principle of the present invention. The disclosed techniques can be variously modified and changed by those skilled in the art, and are not limited to the accurate configurations and the application examples, illustrated and described above. In addition, the configurations of individual sections can be replaced with arbitrary configurations having the same functions. In addition, another arbitrary constituent object or another arbitrary process may be added to the disclosed techniques. In addition, more than one arbitrary configuration of the embodiment mentioned above may be combined into the disclosed techniques. In addition, all modifications and equivalents corresponding to the disclosed techniques are regarded as within the scope of the present invention, based on the appended claims or the equivalents thereof.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

What is claimed is:

1. An electronic device comprising:
a first body having a first battery; and
a second body having a second battery, the second body being configured to be electrically connected to the first body and separatable from the first body;
wherein
the first body includes:
a receiving unit that receives a charge request from the first body or the second body, the charge request being associated with the first battery or the second battery;
a retrieval unit that retrieves a remaining amount of battery charge of the first battery and a remaining amount of charge of the second battery;
a comparison unit that compares the remaining amount of battery charge of the first battery and the remaining amount of battery charge of the second battery;
a control unit that carries out a charging process for the first battery or second battery associated with the charge request in a case that a power source including the first or second battery not associated with the charge request satisfies a condition based on the comparing.

2. The electronic device according to claim 1, wherein the condition is that the first or second battery not associated with the charge request is completely charged.

3. The electronic device according to claim 1, wherein the condition is that the remaining amount of charge in the first or second battery not associated with the charge request is greater than the remaining amount of charge in the first or second battery associated with the charge request.

4. The electronic device according to claim 1, wherein the condition is that the remaining amount of charge in the first or second battery not associated with the charge request is above a specified threshold.

5. The electronic device according to claim 1, wherein a power source of the first body charges the second battery.

6. The electronic device according to claim 1, wherein a power source of the second body charges the first battery.

7. A memory storing a computer program, which when executed by a processor of a first body which is connectable electrically to a second body and is separatable from the second body, causes the processor to perform a method comprising:
receiving a charge request for charging a battery, the charge request being associated with a first battery of the first body or a second battery of the second body;
retrieving a remaining amount of battery charge of the first battery and a remaining amount of battery charge of the second battery;
comparing the remaining amount of battery charge of the first battery and the remaining amount of battery charge of the second battery;
charging the first or second battery associated with the charge request in a case that a power source including the first or second battery not associated with the charge request satisfies a condition based on the comparing.

8. The memory storing the computer program according to claim 7, wherein the condition is that the first or second battery not associated with the charge request is completely charged.

9. The memory storing the computer program according to claim 7, wherein the condition is that the remaining amount of charge in the first or second battery not associated with the charge request is greater than the remaining amount of charge in the first or second battery associated with the charge request.

10. The memory storing the computer program according to claim 7, wherein the condition is that the remaining amount of charge in the first or second battery not associated with the charge request is above a specified threshold.
